(19) United States
(12) Patent Application Publication
(10) Pub. No.: US 2026/0260461 A1
(43) Pub. Date: Sep. 3, 2026

(54) ELECTRONIC DEVICE, METHOD, AND NON-TRANSITORY COMPUTER-READABLE STORAGE MEDIUM FOR OBJECT RECOGNITION

(71) Applicant: THINKWARE CORPORATION, Seongnam-si (KR)

(72) Inventors: Sukpil KO, Seongnam-si (KR); Dongwoo PARK, Seongnam-si (KR); Taekyu HAN, Seongnam-si (KR)

(21) Appl. No.: 19/553,246

(22) Filed: Feb. 28, 2026

(30) Foreign Application Priority Data
Feb. 28, 2025 (KR) 10-2025-0026728
Feb. 27, 2026 (KR) 10-2026-0037175

(51) Int. Cl. G06V 10/764; B60W 50/14; G06V 10/774

(52) U.S. Cl. CPC G06V 10/764; G06V 10/774; B60W 50/14

(57) ABSTRACT

A computer-readable storage medium is described. The computer-readable storage medium stores one or more programs. The one or more programs, when executed by at least one processor of an electronic device including a camera, cause the electronic device to obtain a first image via the camera, perform object recognition on objects included in the first image by executing a first artificial intelligence model using the first image, obtain, as result information of the object recognition, class information indicating the objects recognized in respective regions of the first image, the first artificial intelligence model is trained by a second artificial intelligence model based on distillation learning, and the second artificial intelligence model is configured to generate an embedding vector from a second image, and is trained to distinguish objects included in the second image based on the embedding vector.

### TECHNICAL FIELD

The present disclosure relates to an electronic device, a method, and a computer-readable storage medium for object recognition.

### BACKGROUND

After obtaining an image through a camera, it is necessary to distinguish objects included in the image. In such an object distinguishing process, there is an increasing demand for a technology for more accurately recognizing and identifying the objects included in the image by using artificial intelligence. In particular, an artificial intelligence-based technology capable of effectively distinguishing various objects within the image, by including objects belonging to the same class, is required.

The above-described information may be provided as a related art for the purpose of helping understanding of the present disclosure. No argument or decision is made as to whether any of the above description may be applied as a prior art related to the present disclosure.

### SUMMARY

### Technical Solution

A computer-readable storage medium is described. The computer-readable storage medium may store one or more programs. The one or more programs, when executed by at least one processor of an electronic device including a camera, may cause the electronic device to obtain a first image via the camera, perform object recognition on objects included in the first image by executing a first artificial intelligence model using the first image, obtain, as result information of the object recognition, class information indicating the objects recognized in respective regions of the first image, and the first artificial intelligence model may be trained by a second artificial intelligence model based on distillation learning. The second artificial intelligence model may be configured to generate an embedding vector from a second image, and may be trained to distinguish objects included in the second image based on the embedding vector.

A method is described. The method may train an artificial intelligence model. The method may comprise obtaining, using an image, feature information corresponding to the image by executing the artificial intelligence model, generating, from the feature information, a first embedding vector based on an embedding space representing relationships among words, comparing the first embedding vector with second embedding vectors respectively corresponding to class words for classifying classes of objects, and based on the comparison between the first embedding vector and the second embedding vectors, training the artificial intelligence model.

An electronic device is described. The electronic device may execute an artificial intelligence model. The electronic device may comprise a camera, memory, and a processor. The processor may be configured to cause the electronic device to obtain a first image via the camera, perform object recognition on objects included in the first image by executing a first artificial intelligence model using the first image, obtain, as result information of the object recognition, class information indicating the objects recognized in respective regions of the first image, and the first artificial intelligence model may be trained by a second artificial intelligence model based on distillation learning. The second artificial intelligence model may be configured to generate an embedding vector from a second image, and may be trained to distinguish objects included in the second image based on the embedding vector.

### BRIEF DESCRIPTION OF DRAWINGS

FIG. 1 is a simplified block diagram of an electronic device of the present invention.

FIG. 2 illustrates an embodiment of distillation learning of a first artificial intelligence model through a second artificial intelligence model.

FIG. 3 illustrates an embodiment for training the second artificial intelligence model of FIG. 2.

FIG. 4A illustrates an embodiment in which the second artificial intelligence model of FIG. 3 performs object recognition based on an embedding vector.

FIG. 4B illustrates an embodiment in which the second artificial intelligence model of FIG. 3 performs object recognition based on an embedding vector.

FIG. 5 illustrates an embodiment in which the second artificial intelligence model of FIG. 3 generates a mask for each object.

FIG. 6 illustrates an embodiment in which the second artificial intelligence model of FIG. 3 generates a mask for each object.

FIG. 7 is a flowchart illustrating an embodiment of an operation of the electronic device of FIG. 1.

FIG. 8 illustrates an example of a block diagram illustrating an autonomous driving system of a vehicle according to an embodiment.

FIG. 9 and FIG. 10 illustrate examples of block diagrams illustrating an autonomous driving mobile body according to an embodiment.

FIG. 11 illustrates an example of a gateway related to a user device according to various embodiments.

FIG. 12 is a diagram for describing an operation of an electronic device for training a neural network based on a set of training data according to an embodiment.

FIG. 13 is a block diagram of an electronic device according to an embodiment.

FIG. 14 is a functional block diagram of an autonomous driving system for planning a driving path using an object recognition result according to another embodiment of the present invention.

FIG. 15 is a conceptual diagram illustrating a process in which different optimal paths are generated according to a mission objective even when the same start point and the same goal point are provided on the same traversability map according to an embodiment of the present invention.

FIG. 16 is a conceptual diagram for more specifically describing an operation of the mission planner and the path planner illustrated in FIG. 14.

FIG. 17 is a flowchart illustrating a flow of an optimal path generation algorithm according to an embodiment of the present invention.

FIG. 18 is a conceptual diagram comprehensively illustrating a process in which different optimal paths are generated by applying a dynamic cost function according to a mission objective even when the same terrain environment is input according to an embodiment of the present invention.

FIG. 19 is a flowchart illustrating a flow of a method for planning an autonomous driving path on an unpaved road according to an embodiment of the present invention.

### DETAILED DESCRIPTION

In the following drawings, identical, similar, or corresponding reference numerals may be assigned to an identical, similar, or corresponding configuration, and duplicated descriptions thereof may not be repeated. In the description with reference to a specific drawing below, reference numerals of other drawings may be referred to.

In the present specification, an expression “A, B, or C (A, B, or C)” is used in an inclusive sense including “A”, “B”, “C”, or “any combination thereof”, unless clearly stated otherwise in the context. In addition, an expression “at least one of A, B, and C” should be interpreted to include a meaning including “A alone”, “B alone”, “C alone”, or “any combination of two or more of A, B, and C”, and selectively including respective components, even though a grammatical conjunction ‘and’ is used. Furthermore, such a definition is applied in the same manner even in a case that the number of the described elements is three or more.

In the present disclosure, a description “A, B, and/or C” is merely a simplified expression for brevity of a sentence, and should be interpreted as being identical to a case in which each of “A alone”, “B alone”, “C alone”, “A and B”, “A and C”, “B and C”, and “A, B, and C as a whole” is individually and specifically described. For example, a description that a component includes “A, B, and/or C” should be interpreted as being identical to that the component may selectively include “A”, may include “B”, may include “C”, may include “A and B”, may include “A and C”, may include “B and C”, or may include “A, B, and C”.

In the present disclosure, a singular expression includes a plurality of objects, unless clearly indicated otherwise in the context, and a plural expression is also intended to include a singular object, unless clearly indicated otherwise in the context. For example, a reference to “an element” includes “one or more elements”, and a reference to “elements” may include “one element”.

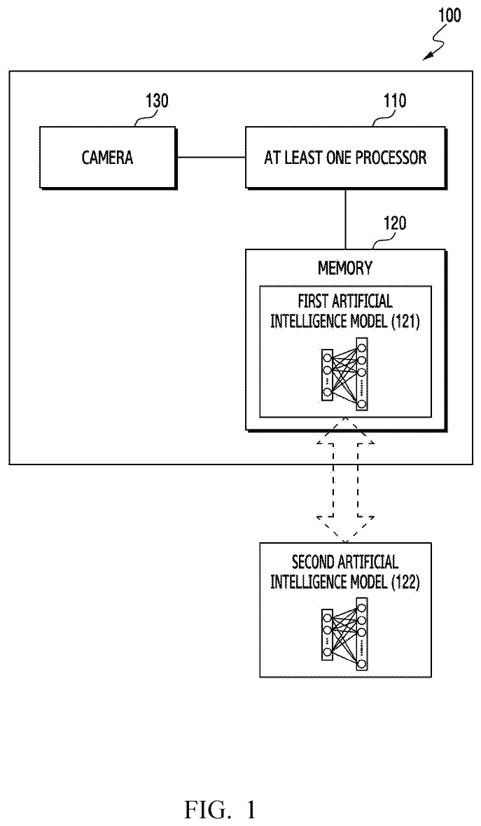

FIG. 1 is a simplified block diagram of an electronic device of the present invention.

Referring to FIG. 1, an electronic device 100 may include at least one processor 110, memory 120, and a camera 130. An embodiment of the present disclosure is not limited thereto. The electronic device 100 may further include other components in addition to the above described components.

The at least one processor 110 may be an application processor (AP) implemented as a system-on-chip (SoC) in the electronic device 100, but is not limited thereto. The at least one processor 110 may perform operations according to embodiments of the present disclosure by executing instructions stored in the memory 120. The at least one processor 110 may execute or control one or more software modules, firmware, and/or hardware logic.

The memory 120 may include one or more storage media, and may store instructions executed by the processor 110. The memory 120 may store various programs and data executed by the at least one processor 110. For example, the memory 120 may include a volatile memory such as a random-access memory (RAM), and/or a non-volatile memory such as a read-only memory (ROM). The volatile memory may include, for example, at least one of a dynamic RAM (DRAM), a static RAM (SRAM), a cache RAM, and a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, and an embedded multimedia card (EMMC).

In an embodiment, the memory 120 may store a first artificial intelligence model 121. Specifically, the memory 120 may include instructions for executing the first artificial intelligence model 121. The first artificial intelligence model 121 may perform object recognition on objects included in an image obtained through the camera 130. The first artificial intelligence model 121 may be referred to as a student model.

In an embodiment, the first artificial intelligence model 121 may be configured to identify an event related to a first image using class information obtained as an object recognition result. The at least one processor 110 may control to output an alarm corresponding thereto in a case that the event is identified. Accordingly, the electronic device 100 may automatically detect the event based on the object recognition result and may provide the alarm to a user.

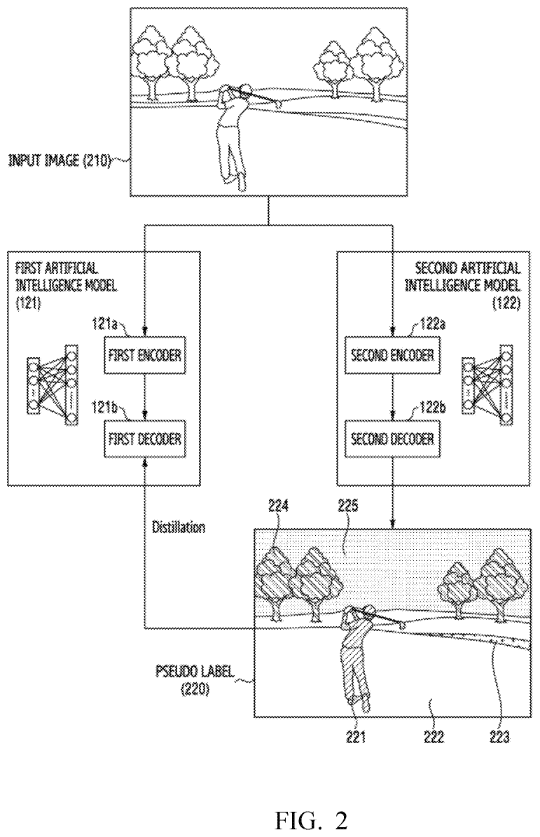

In an embodiment, the memory 120 may further store information on a second artificial intelligence model 122 or result information generated from the second artificial intelligence model 122. The second artificial intelligence model 122 may be a model pre-trained based on a large-scale datasets. The second artificial intelligence model 122 may be referred to as a teacher model for training the first artificial intelligence model 121. The first artificial intelligence model 121 may be trained based on distillation learning by referring to output data generated by the second artificial intelligence model 122 (e.g., see FIG. 2). The first artificial intelligence model 121 and the second artificial intelligence model 122 will be described later with reference to FIG. 2.

The camera 130 may be configured to obtain image data by capturing an external environment of the electronic device 100. The at least one processor 110 may control to perform object recognition on objects included in the image by inputting the image data obtained through the camera 130 to the first artificial intelligence model 121. A result of the object recognition performed by the first artificial intelligence model 121 may be used for various application functions executed in the electronic device 100, for example, event identification, user notification, warning output, or a driving assistance function, and the like.

In an embodiment, the electronic device 100 may be a device attachable to a vehicle or a device mountable on a mobile body. Accordingly, the camera 130 may be mounted on the vehicle, and may be configured to perform object recognition by capturing a surrounding environment of the vehicle. The vehicle may include a golf cart, an agricultural machine, a cart operated without a driver, an autonomous driving vehicle, and/or a remotely controlled vehicle. However, the embodiment of the present disclosure is not limited thereto.

The second artificial intelligence model 122 illustrated in FIG. 1 may be executed in a server, a cloud system, or a separate computing device disposed outside the electronic device 100, but the embodiment of the present disclosure is not limited thereto. The second artificial intelligence model 122 may be executed by being stored in the memory 120 in the electronic device 100.

FIG. 2 illustrates an embodiment of distillation learning of a first artificial intelligence model through a second artificial intelligence model. Specifically, FIG. 2 illustrates an embodiment of training a first artificial intelligence model 121, which is a student model, through a second artificial intelligence model 122, which is a teacher model.

Referring to FIG. 2, in an embodiment, the first artificial intelligence model 121 may include a first encoder 121a and a first decoder 121b. The second artificial intelligence model 122 may include a second encoder 122a and a second decoder 122b.

The first encoder 121a of the first artificial intelligence model 121 may be an encoder trained by referring to output data generated by the second encoder 122a. The second encoder 122a of the second artificial intelligence model 122 may be an encoder pre-trained based on a large-scale datasets. The first encoder 121a and the second encoder 122a may extract feature information including a shape, a boundary, and/or a semantic characteristic of an object from an input image 210.

The first decoder 121b of the first artificial intelligence model 121 may generate an object recognition result on objects included in the input image 210 using feature information output from the first encoder 121a. In addition, the second decoder 122b may generate an object recognition result on objects included in the input image 210 using feature information output from the second encoder 122a.

The second decoder 122b of the second artificial intelligence model 122 may generate a pseudo label 220 including class information of the objects included in the input image 210 and region information in which the objects are located. At least one processor 110 may train the first decoder 121b by referring to the pseudo label 220 such that the object recognition result generated by the first artificial intelligence model 121 becomes close to the pseudo label 220. Accordingly, the first artificial intelligence model 121 may be trained to reflect object recognition performance of the second artificial intelligence model 122 by performing distillation learning based on the object recognition result generated by the second artificial intelligence model 122.

In an embodiment, the second artificial intelligence model 122 may generate the pseudo label 220 in which the objects are distinguished based on the input image 210. The pseudo label 220 may include a person object 221, a grass object 222, a road object 223, a tree object 224, and/or a sky object 225. An embodiment of the present disclosure is not limited thereto.

In an embodiment, the input image 210 may be provided to the first artificial intelligence model 121 and the second artificial intelligence model 122. In FIG. 2, the input image 210 input to the first artificial intelligence model 121 and the second artificial intelligence model 122 is illustrated as being identical, but the embodiment of the present disclosure is not limited thereto. For example, a second image may be input to the second artificial intelligence model 122, and a first image different from the second image may be input to the first artificial intelligence model 121.

For example, the second artificial intelligence model 122 may perform object recognition by using images included in the large-scale datasets and/or images collected in an external environment as an input, and may generate a pseudo label 220 based thereon. On the other hand, the first artificial intelligence model 121 may be trained by using an image obtained in real time through a camera 130 of an electronic device 100 or separate images not input to the second artificial intelligence model 122 as an input.

Accordingly, the first artificial intelligence model 121 may be subjected to distillation learning (knowledge distillation) to learn object recognition characteristics of the second artificial intelligence model 122 not only for the same input image but also for different input images. According to such a configuration, the first artificial intelligence model 121 may secure generalized object recognition performance for various environments and object distributions without depending on training data limited by the second artificial intelligence model 122.

In an embodiment, the first artificial intelligence model 121 may perform object recognition by using the input image 210, and may generate output data for the input image 210. The at least one processor 110 may control to train the first artificial intelligence model 121 based on a difference between the pseudo label 220 generated by the second artificial intelligence model 122 and the output data generated by the first artificial intelligence model 121. For example, the at least one processor 110 may update a parameter of the first artificial intelligence model 121 such that the output data of the first artificial intelligence model 121 becomes closer to the pseudo label 220. Accordingly, the first artificial intelligence model 121 may be trained to reflect the object recognition performance of the second artificial intelligence model 122.

A method of training the first artificial intelligence model 121 through the second artificial intelligence model 122 may be performed by using Equation 1 and Equation 2 below.

$${z}^{s} = {\{ ( {c}_{i}^{s} , {m}_{i}^{s} ) \vert {c}_{i}^{s} ∈ \{ 1 , … , K \} , {m}_{i}^{s} ∈ {\{ 0 , 1 \}}^{H \times W} \}}_{i = 1}^{{N}^{s}} \qquad [ Equation 1 ]$$

A prediction result generated by the first artificial intelligence model (for example, the student model) 121 according to input of the input image 210 may be defined as illustrated in the Equation 1.

In the Equation 1, z^{s} may represent a prediction set generated by the first artificial intelligence model 121. The prediction set z^{s} may be configured with a plurality of object candidates, and each object candidate may be represented by class information

$${c}_{i}^{s}$$

and mask information

$${m}_{i}^{s}$$

representing a region of a corresponding object. In addition, the prediction set may include N^{s} object predictions generated corresponding to a plurality of learnable queries.

$${ℒ}_{mask} ( {z}^{s} , {z}^{t} ) = {\sum }_{j = 1}^{N} [ - log {p}_{σ ( j )} ( {c}_{j}^{t} ) + {𝕝}_{{c}_{j}^{t} \neq ∅} {ℒ}_{mask} ( {m}_{{σ}_{( j )}} , {m}_{j}^{t} ) ] \qquad [ Equation 2 ]$$

The first artificial intelligence model 121 may be subjected to distillation learning by referring to a prediction result generated by the second artificial intelligence model (for example, the teacher model) 122. A loss function used in the distillation learning may be defined as illustrated in the Equation 2.

In the Equation 2, [symbol] (z^{s},z^{t}) may be a distillation loss function for minimizing a difference between the prediction result z^{s} of the first artificial intelligence model 121 and the prediction result ze of the second artificial intelligence model 122. Herein, z^{t} may represent a pseudo label set generated by the second artificial intelligence model 122. The loss function may be calculated based on a bipartite matching result σ(j) for matching a prediction of the first artificial intelligence model 121 and a prediction of the second artificial intelligence model 122.

Since the distillation learning illustrated in FIG. 2 may train the first artificial intelligence model 121 by using the pseudo label (pseudo truth) 220 generated by the second artificial intelligence model 122 instead of a ground truth label directly generated by a person, it may improve object recognition performance of the first artificial intelligence model 121 while reducing a labeling cost. In addition, in a case that the second artificial intelligence model 122 is a model pre-trained based on the large-scale datasets, since representation capability in various environments may be transferred to the first artificial intelligence model 121, generalization performance of the first artificial intelligence model 121 may be improved.

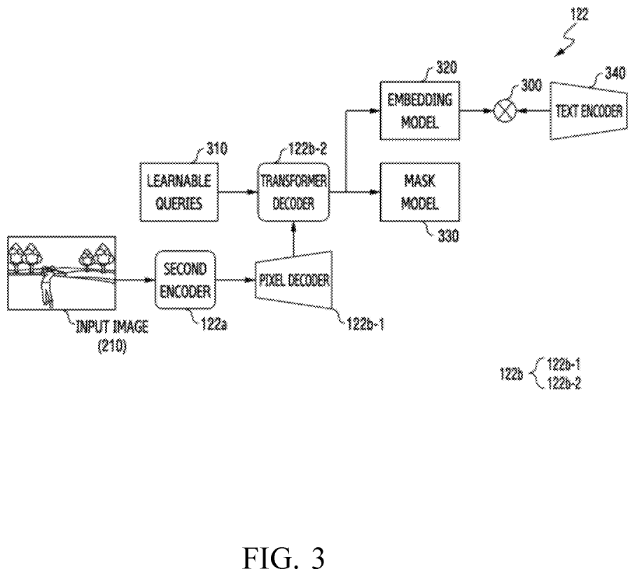

FIG. 3 illustrates an embodiment of training the second artificial intelligence model of FIG. 2. In FIG. 3, it is described by focusing on an embodiment in which an input image 210 is input to the second artificial intelligence model 122.

Referring to FIG. 3, a decoder 122b of the second artificial intelligence model may include, in order to process feature information output from an encoder 122a, a pixel decoder 122b-1 for generating feature information in units of pixel and a transformer decoder 122b-2 for performing inference in units of object based on the feature information in units of pixel.

The input image 210 may be input to the encoder 122a of the second artificial intelligence model. The second encoder 122a may extract feature information reflecting a shape, a boundary, and a semantic characteristic of objects included in the input image 210 by performing a plurality of neural network operations on the input image 210.

The pixel decoder 122b-1 may receive the feature information output from the second encoder 122a. The pixel decoder 122b-1 may aggregate the extracted feature information and then convert it into feature information corresponding to a size and a shape of the input image 210. For example, the pixel decoder 122b-1 may combine feature information having different resolutions and gradually restore a resolution thereby generating feature information corresponding to each position of the input image 210. Accordingly, the pixel decoder 122b-1 may provide basic information available to determine which object each pixel or pixel region of the input image 210 belongs to.

The transformer decoder 122b-2 may receive the feature information generated by the pixel decoder 122b-1. The transformer decoder 122b-2 may generate feature information in units of object corresponding to each of objects included in an input image 210 by performing an operation on the entire feature information in units of pixel by receiving a plurality of learnable queries 310 as an input. The learnable queries 310 may be learned in the transformer decoder 122b-2, and may be used as data for extracting features in units of object independently of the number, a position, or a shape of the objects included in the input image 210.

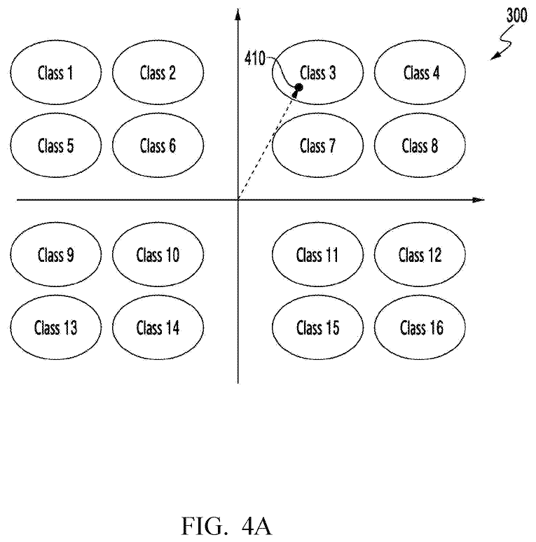

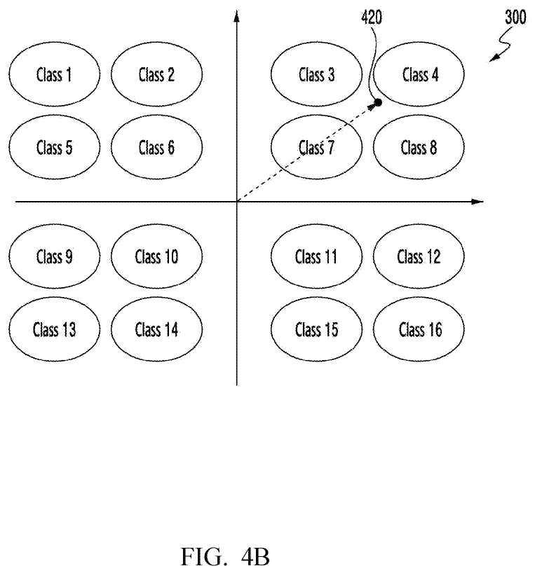

The transformer decoder 122b-2 may generate an object embedding vector (for example, an object embedding vector 410 of FIG. 4A) through an embedding model 320 based on the feature information in units of object. The object embedding vector 410 may be a vector representation representing a semantic characteristic of an object included in the input image 210. In addition, the transformer decoder 122b-2 may generate a mask representing a region of an object corresponding to the object embedding vector 410 through a mask model 330. Accordingly, the second artificial intelligence model may generate masks in units of object for each of a plurality of objects included in the input image 210. The embedding model 320 may be referred to as an object embedding generation unit. The mask model 330 may be referred to as a mask generation unit.

Meanwhile, the second artificial intelligence model 122 may further include a text encoder 340 as a criterion for determining a class of an object. The text encoder 340 may receive class words representing classes of objects as an input, and then may generate a class embedding vector (for example, a class 1 to a class 16 of FIG. 4A) corresponding to each class word. The object embedding vector 410 generated by the embedding model 320 may be compared in the same embedding space 300 as class embedding vectors generated by the text encoder 340. For example, the second artificial intelligence model 122 may calculate a similarity between the object embedding vector 410 and a plurality of class embedding vectors, and may determine a class corresponding to a class word having the highest similarity as a class of a corresponding object.

As described above, the second artificial intelligence model 122 illustrated in FIG. 3 may comprehensively analyze the objects included in the input image 210 in units of pixel, in units of object, and in units of semantic through a structure in which the second encoder 122a, the pixel decoder 122b-1, the transformer decoder 122b-2, the embedding model 320, the mask model 330, and the text encoder 340 are organically connected. In addition, by determining a class of an object based on a comparison with embedding vectors of class words, object recognition may be performed for various classes without depending on parameters of a pre-fixed classifier. Accordingly, the second artificial intelligence model 122 may be trained as a model having excellent class scalability, and such a training result may be used as reference information for distillation learning of a first artificial intelligence model (for example, the first artificial intelligence model 121 of FIG. 2) as illustrated in FIG. 2.

In an embodiment, the second artificial intelligence model 122 may be trained based on a similarity calculation between the object embedding vector (for example, the object embedding vector 410 of FIG. 4A) and the class embedding vector (for example, the class 1 to the class 16 of FIG. 4A). Specifically, the object embedding vector 410 generated by the transformer decoder 122b-2 may be compared with a class embedding vector generated by the text encoder 340, and a similarity at this time may be calculated as illustrated in Equation 3.

$${p}^{k} = \frac{{ϵ}_{query} \cdot {( {ϵ}_{text} )}^{T}}{τ} \qquad [ Equation 3 ]$$

In the Equation 3, p^{k} may be a value representing a similarity between an object embedding vector e_{query} and a class embedding vector eₜₑₓₜ, and r may be a temperature parameter for adjusting a scale of a similarity distribution.

That is, the Equation 3 may be an equation representing how similar the object embedding vector 410 and the class embedding vector are in the same embedding space in a quantitative manner. At least one processor 110 may train the second artificial intelligence model 122 through a loss function based on contrastive learning by using a result of the similarity calculation.

For example, the loss function used in the contrastive learning may be defined as illustrated in Equation 4.

$$ℒ = \frac{1}{N} {\sum }_{i = 0}^{N - 1} - log \frac{exp ( {p}_{i , j +}^{k} )}{{\sum }_{j = 0}^{{K}_{k}} exp ( {p}_{i , j}^{k} )} \qquad [ Equation 4 ]$$

An electronic device 100 may train the second artificial intelligence model 122 based on the contrastive learning by using the loss function of the Equation 4. For example, in the Equation 4, by inputting a negative sample for which a value having a relatively large difference from the current class pj is to be output to a denominator, and inputting the current class pj to a numerator, a result value of the loss function may be calculated. N of the Equation 4 may represent a total number of segment queries, and k may represent the number of data sets.

In the Equation 4, a term included in the numerator may correspond to a similarity value between a current object embedding and a ground truth class embedding, and terms included in the denominator may include similarity values for negative classes that should have a relatively large difference from the current class. Accordingly, the electronic device may train the second artificial intelligence model 122 such that a high similarity is output for the ground truth class and a low similarity is output for non-ground truth classes.

Accordingly, the second artificial intelligence model 122 may learn a relationship between an object embedding vector and a class embedding vector more precisely, and such a learning result may be used to generate a pseudo label for distillation learning of the first artificial intelligence model 121 as described in FIG. 2.

FIG. 4A illustrates an embodiment in which the second artificial intelligence model of FIG. 3 performs object recognition based on an embedding vector.

Referring to FIG. 4A, class embedding vectors (a class 1 to a class 16) respectively corresponding to a plurality of classes may be disposed in an embedding space 300. The class embedding vectors may be embedding vectors of a class word generated by a text encoder (for example, the text encoder 340 of FIG. 3), and each class may be disposed at a position that is semantically distinguishable from each other.

In an embodiment, the class 1 may correspond to a bird, a class 2 may correspond to a ground animal, a class 3 may correspond to a road, and a class 4 may correspond to a grass. As described above, the class 1 to the class 16 may correspond to various terms. In FIG. 4A, 16 classes are illustrated as being in the embedding space 300, however, an embodiment of the present disclosure is not limited thereto. In the embedding space 300, 17 or more numerous classes may correspond to various terms and may be positioned. In addition, terms for the class 1 to the class 4 described above are exemplary, and the embodiment of the present disclosure is not limited thereto.

In an embodiment, as illustrated in FIG. 4A, the second artificial intelligence model may determine an object embedding vector 410 corresponding to an object included in an input image 210. The object embedding vector 410 may be a vector generated through a transformer decoder 122b-2 and an embedding model 320 as described in FIG. 3. The object embedding vector 410 may be referred to as a first embedding vector, and class embedding vectors may be referred to as a second embedding vector.

The second artificial intelligence model may compare a similarity between the object embedding vector 410 and a plurality of class embedding vectors. For example, a distance similarity between the object embedding vector 410 and the class embedding vectors respectively corresponding to the class 1 to the class 16 may be calculated. For example, as illustrated in FIG. 4A, a third class corresponding to a class embedding vector having the highest similarity with the object embedding vector 410 may be determined as a class of the object included in the input image 210. In an example of FIG. 4A, since the object embedding vector 410 is disposed within a class embedding vector corresponding to the class 3, the second artificial intelligence model 122 may recognize that the object included in the input image 210 is an object corresponding to a road.

FIG. 4B illustrates an embodiment in which the second artificial intelligence model of FIG. 3 performs object recognition based on an embedding vector. A description referring to FIG. 4B may partially overlap with the description referring to FIG. 4A. Accordingly, overlapping content may be omitted or simplified. In an example illustrated in FIG. 4B, a case in which an object embedding vector 420 does not exactly exist within a class embedding vector is illustrated.

Referring to FIG. 4B, class embedding vectors respectively corresponding to a plurality of classes may be disposed in an embedding space 300. The class embedding vectors may be embedding vectors of a class word generated by a text encoder (for example, the text encoder 340 of FIG. 3).

In an embodiment, the second artificial intelligence model may generate the object embedding vector 420 corresponding to an object included in an input image 210. The object embedding vector 420 may be a vector representation reflecting a semantic characteristic of the object included in the input image 210.

In this case, the second artificial intelligence model 122 may compare a similarity between the object embedding vector 420 and a plurality of class embedding vectors (a class 1 to a class 16). For example, distances between the object embedding vector 420 and the class embedding vectors respectively corresponding to each class may be calculated. As a result, a class corresponding to a class embedding vector having the highest similarity with the object embedding vector 420 may be selected as a class of a corresponding object. For example, in an example of FIG. 4B, since the object embedding vector 420 is disposed at a position closest to a class embedding vector corresponding to a class 4, the second artificial intelligence model 122 may recognize the object included in the input image 210 as an object corresponding to the class 4.

As described above, the second artificial intelligence model 122 may perform object recognition based on a relative positional relationship in the embedding space 300 and a similarity comparison even in a case that a class embedding vector exactly matching the object embedding vector 410 does not exist. Accordingly, flexible object recognition may be possible even for an object not defined in advance or an object observed in a new environment that is not generalized.

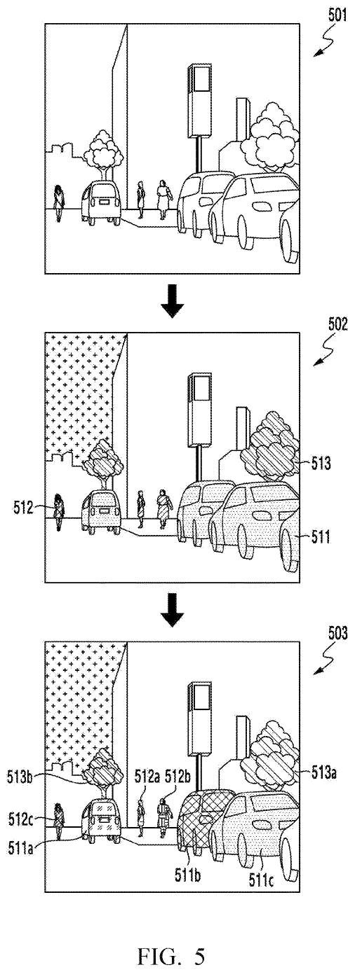

FIG. 5 illustrates an embodiment in which the second artificial intelligence model of FIG. 3 generates a mask for each object. Specifically, a process of performing class classification and object recognition for a plurality of objects included in an input image in a paved road environment and a result thereof are illustrated step by step.

Referring to FIG. 5, a first image 501 represents an input image obtained through a camera (for example, the camera 130 of FIG. 1). The first image 501 may include a plurality of objects such as a road, a vehicle, a person, and/or a building, and the like.

A second image 502 represents a result of performing class classification on objects included in the first image 501. For example, in the second image 502, regions respectively corresponding to different classes such as the road, the vehicle, the person, and the like, may be displayed in different colors or patterns. As described above, the second image 502 represents a result of distinguishing the objects included in the input image 501 in units of class, and objects belonging to the same class may be displayed as the same class. For example, in the second image 502, each of a vehicle object 511, a person object 512, and a tree object 513 may be distinguished into different classes.

A third image 503 represents a result of generating a mask for each object by performing object recognition within each class included in the second image 502. The third image 503 represents an object recognition result configured to distinguish a plurality of objects belonging to the same class into different objects based on the class classification result. The mask may be information representing a region occupied by each object in units of pixel, and different objects may be displayed to be visually distinguishable.

For example, in the third image 503, a class corresponding to the vehicle object 511 may be separated into a plurality of objects. For example, the vehicle object 511 may be classified into a first vehicle object 511a, a second vehicle object 511b, and a third vehicle object 511c. A class corresponding to the person object 512 in the second image 502 may also be distinguished into a first person object 512a and a second person object 512b. A class corresponding to the tree object 513 in the second image 502 may also be separated into a first tree object 513a and a second tree object 513b.

As described above, the second artificial intelligence model 122 may generate a mask so as to distinguish objects belonging to the same class into different objects, without being limited to classifying the objects included in the input image 501 in units of class. Accordingly, the second artificial intelligence model 122 may perform object recognition for generating a mask for each object with respect to each of a plurality of objects included in the input image. The mask may be generated by the mask model 330 of FIG. 3.

An the mask generation result for each object illustrated in FIG. 5 may be used as the pseudo label 220 for distillation learning of the first artificial intelligence model as described in FIG. 2, and may be utilized for training the first artificial intelligence model 121 to distinguish objects belonging to the same class from each other, and position and region information in units of object as well as class information of an object may be learned together.

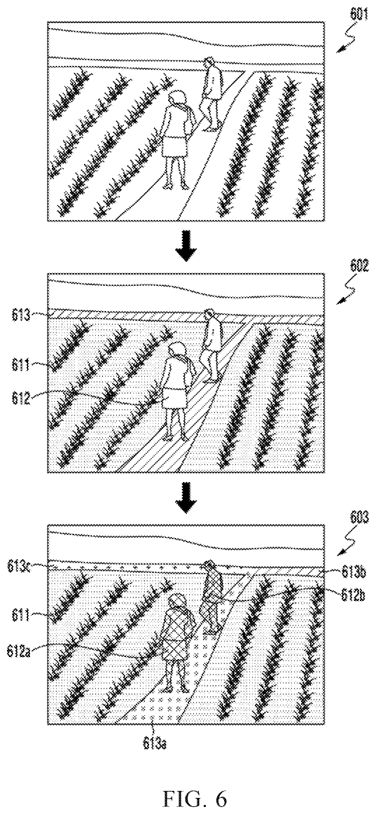

FIG. 6 illustrates an embodiment in which the second artificial intelligence model of FIG. 3 generates a mask for each object. Specifically, FIG. 6 illustrates an embodiment of performing object recognition in an unpaved road environment, for example, a rice field or a farmland environment.

Referring to FIG. 6, a first image 601 represents an input image obtained through a camera, and may include a scene captured in a rice field environment. The first image 601 may include a plurality of objects such as a plant planted in a rice field, a person working, and an unpaved road structure such as a rice field ridge.

A second image 602 represents a result of performing class classification on objects included in the first image 601. For example, in the second image 602, regions respectively corresponding to different classes such as a plant object 611, a person object 612, and a rice field ridge object 613 may be displayed in different colors or patterns. As described above, the second image 602 represents a result of distinguishing the objects included in the input image 601 in units of class, and objects belonging to the same class may be displayed as one class region.

A third image 603 represents a result of generating a mask for each object by performing object recognition within each class included in the second image 602. That is, the third image 603 may represent an object recognition result configured such that a plurality of objects belonging to the same class are distinguished into different objects based on the class classification result.

For example, in the third image 603, a class corresponding to the person object 612 may be distinguished into different objects such as a first person object 612a and a second person object 612b. In addition, a class corresponding to the rice field ridge object 613 may also be distinguished into a plurality of objects such as a first rice field ridge object 613a, a second rice field ridge object 613b, and a third rice field ridge object 613c. The plant object 611 may also be represented as a mask corresponding to an individual region.

As described above, the second artificial intelligence model 122 may generate a mask for each object so as to distinguish objects belonging to the same class into different object instances, not only classifying the objects included in the input image in units of class but also not being limited to a paved road environment and also in the unpaved road environment such as the rice field.

Accordingly, the second artificial intelligence model 122 may support, in a case being applied to an agricultural machine, an autonomous driving vehicle, or work equipment, a control operation such that only a specific object such as a person, a plant, or a rice field ridge is selectively recognized or excluded. For example, in a process in which the agricultural machine moves or performs an operation, it may be possible to control such that a person object is avoided and an operation is selectively performed only for a plant object corresponding to a specific region.

The mask generation result for each object illustrated in FIG. 6 may be used as a pseudo label 220 for distillation learning of the first artificial intelligence model 121 as described in FIG. 2. Accordingly, the first artificial intelligence model 121 may be trained to accurately recognize a class of an object and region information in units of object even in the unpaved road environment, and may secure stable object recognition performance in various environments.

As described above, as described with reference to FIG. 5 and FIG. 6, the second artificial intelligence model 122 may be pre-trained based on a large-scale datasets. For example, the second artificial intelligence model 122 may learn a generalized representation capability for a shape, a boundary, and a semantic characteristic of an object by using the large-scale datasets including various environments, object types, and a background. By such pre-training, a basis for performing object recognition may be provided not only in the paved road environment but also in a complex environment such as the unpaved road and a farmland.

The class information generated by the second artificial intelligence model 122 may further include identification information for distinguishing objects belonging to the same class from each other. For example, a plurality of objects belonging to the same class may be distinguished in units of object as different identification information is respectively assigned. The identification information may be identified as the mask assigned to each object in FIG. 6. Accordingly, an electronic device 100 may individually recognize objects within the same class and may perform a subsequent operation.

Thereafter, object recognition characteristics learned by the second artificial intelligence model 122 may be transferred to the first artificial intelligence model 121 through distillation learning, and the first artificial intelligence model 121 may be fine-tuned by using a target dataset. For example, the first artificial intelligence model 121 may be trained to selectively perform object recognition for a specific object or a specific class by using image data obtained through a camera mounted on an agricultural machine, a vehicle, or a robot device. Accordingly, the first artificial intelligence model 121 may secure object recognition performance optimized for an actual operation environment while maintaining generalized performance of the second artificial intelligence model 122.

By such a configuration, the present invention may, by organically combining pre-training based on the large-scale datasets and fine-tuning based on the target dataset, be effectively applied to an application field in which stable object recognition even in various environments is possible and selective control or operation execution is required only for a specific object.

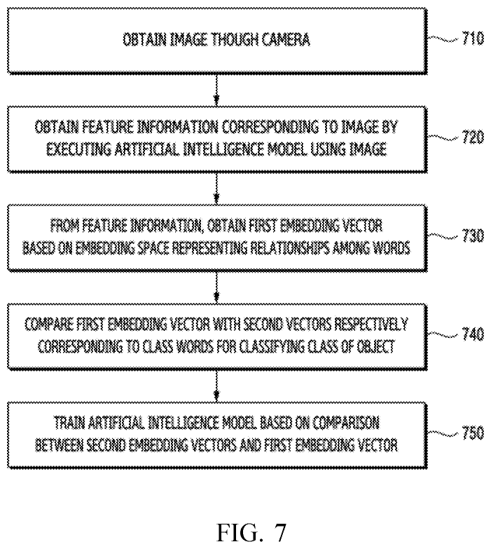

FIG. 7 is a flowchart illustrating an embodiment of an operation of the electronic device of FIG. 1.

Referring to FIG. 7, in operation 710, the at least one processor 110 may obtain an input image 210 by capturing an external environment through the camera 130. The input image 210 may be an image captured in various environments such as a road environment, an unpaved road environment, and a farmland environment, and may include a plurality of objects such as a person, a vehicle, a plant, a ground, and a structure.

In operation 720, the at least one processor 110 may execute the artificial intelligence model using the obtained input image 210 and may obtain feature information corresponding to the input image 210. In an embodiment, the artificial intelligence model may be the second artificial intelligence model 122 described in FIG. 3, and the second artificial intelligence model 122 may process the input image 210 through an encoder to extract feature information reflecting a shape, a boundary, and a semantic characteristic of an object.

In operation 730, the at least one processor 110 may obtain a first embedding vector based on an embedding space reflecting a semantic relationship among words from the feature information. In an embodiment, the first embedding vector may be an object embedding vector generated through the transformer decoder 122b-2 and the embedding model 320, and may represent a semantic characteristic of an object included in the input image 210 in a form of a vector.

In operation 740, the at least one processor 110 may compare the first embedding vector and a second embedding vector each corresponding to class words to classify a class of a subject. In an embodiment, the second embedding vector may be a class embedding vector (e.g., the class 1 to the class 16 of FIG. 4A) generated by a text encoder, and similarity comparison between the first embedding vector and the second embedding vector may be performed in the same embedding space. For example, similarity between the first embedding vector and a plurality of second embedding vectors may be calculated, and a class corresponding to a class word having the highest similarity may be determined as the class of the subject.

In operation 750, the at least one processor 110 may train the artificial intelligence model based on a comparison result of the second embedding vector and the first embedding vector. In an embodiment, the training may be performed based on contrastive learning, and parameters of the artificial intelligence model may be updated such that an object embedding vector becomes closer to a class embedding vector corresponding to a correct class and becomes farther from a class embedding vector corresponding to an incorrect class. In addition, a result of the training may be used as reference information for distillation learning of the first artificial intelligence model as described in FIG. 2.

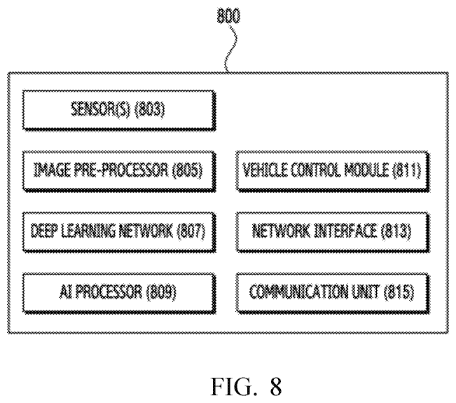

Referring to FIG. 8, FIG. 8 illustrates an example of a block diagram illustrating an autonomous driving system of a vehicle according to an embodiment.

The autonomous driving system 800 of the vehicle according to FIG. 8 may be a deep learning network including sensors 803, an image pre-processor 805, a deep learning network 807, an artificial intelligence (AI) processor 809, a vehicle control module 811, a network interface 813, and a communication unit 815. In various embodiments, each of elements may be connected through various interfaces. For example, sensor data sensed and outputted by the sensors 803 may be fed to the image pre-processor 805. The sensor data processed by the image pre-processor 805 may be fed to the deep learning network 807 running on the AI processor 809. An output of the deep learning network 807 running by the AI processor 809 may be fed to the vehicle control module 811. Intermediate results of the deep learning network 807 running on the AI processor 809 may be fed to the AI processor 809. In various embodiments, the network interface 813 delivers autonomous driving route information and/or autonomous driving control commands for autonomous driving of the vehicle to internal block configurations, by performing communication with an electronic device (e.g., the electronic device 100 of FIG. 1) in the vehicle. In an embodiment, the network interface 813 may be used to transmit the sensor data obtained through the sensor(s) 803 to an external server. In some embodiments, the autonomous driving control system 800 may include additional or fewer components as appropriate. For example, in some embodiments, the image pre-processor 805 may be an optional component. For another example, a post-processing component (not illustrated) may be included in the autonomous driving control system 800 to perform post-processing on the output of the deep learning network 807 before the output is provided to the vehicle control module 811.

In some embodiments, the sensors 803 may include one or more sensors. In various embodiments, the sensors 803 may be attached to different locations of the vehicle. The sensors 803 may face one or more different directions. For example, the sensors 803 may be attached to a front, sides, a rear, and/or a roof of the vehicle to face directions such as forward-facing, rear-facing, and side-facing. In some embodiments, the sensors 803 may be image sensors such as high dynamic range cameras. In some embodiments, the sensors 803 include non-visual sensors. In some embodiments, the sensors 803 include RADAR, Light Detection And Ranging (LiDAR), and/or ultrasonic sensors in addition to an image sensor. In some embodiments, the sensors 803 are not mounted on a vehicle having the vehicle control module 811. For example, the sensors 803 may be included as a portion of a deep learning system for capturing the sensor data and may be attached to an environment or a roadway and/or mounted on nearby vehicles.

In some embodiments, the image pre-processor 805 may be used to pre-process the sensor data of the sensors 803. For example, the image pre-processor 805 may be used to preprocess the sensor data, to split the sensor data into one or more components, and/or to post-process one or more components. In some embodiments, the image pre-processor 805 may be a graphics processing unit (GPU), a central processing unit (CPU), an image signal processor, or a specialized image processor. In various embodiments, the image pre-processor 805 may be a tone-mapper processor for processing high dynamic range data. In some embodiments, the image pre-processor 805 may be a component of the AI processor 809.

In some embodiments, the deep learning network 807 may be a deep learning network for implementing control commands for controlling an autonomous vehicle. For example, the deep learning network 807 may be an artificial neural network such as a convolution neural network (CNN) trained by using the sensor data, and the output of the deep learning network 807 is provided to the vehicle control module 811.

In some embodiments, the artificial intelligence (AI) processor 809 may be a hardware processor for running the deep learning network 807. In some embodiments, the AI processor 809 is a specialized AI processor for performing inference on the sensor data through the convolution neural network (CNN). In some embodiments, the AI processor 809 may be optimized for a bit depth of the sensor data. In some embodiments, the AI processor 809 may be optimized for deep learning computations, such as computations of a neural network including a convolution, a dot product, a vector and/or matrix computations. In some embodiments, the AI processor 809 may be implemented through a plurality of graphics processing units (GPUs) capable of effectively performing parallel processing.

In various embodiments, the AI processor 809 may be coupled, through an input/output interface, to memory configured to perform a deep learning analysis on the sensor data received from the sensor(s) 803 while the AI processor 809 is running and to provide an AI processor having commands that cause to determine a machine learning result used to operate the vehicle at least partially autonomously. In some embodiments, the vehicle control module 811 may be used to process commands for vehicle control outputted from the artificial intelligence (AI) processor 809 and translate the output of the AI processor 809 into commands for controlling a module of each vehicle to control various modules of the vehicle. In some embodiments, the vehicle control module 811 is used to control a vehicle for autonomous driving. In some embodiments, the vehicle control module 811 may adjust steering and/or speed of the vehicle. For example, the vehicle control module 811 may be used to control traveling of the vehicle such as deceleration, acceleration, steering, lane change, lane keeping, and the like. In some embodiments, the vehicle control module 811 may generate control signals for controlling vehicle lighting, such as brake lights, turns signals, headlights, and the like. In some embodiments, the vehicle control module 811 may be used to control vehicle audio-related systems such as a vehicle's sound system, vehicle's audio warnings, a vehicle's microphone system, a vehicle's horn system, and the like.

In some embodiments, the vehicle control module 811 may be used to control notification systems, including warning systems to notify passengers and/or a driver of driving events, such as approach of an intended destination or a potential collision. In some embodiments, the vehicle control module 811 may be used to adjust sensors, such as the sensors 803 of the vehicle. For example, the vehicle control module 811 may modify the orientation of the sensors 803, change output resolution and/or a format type of the sensors 803, increase or decrease a capture rate, adjust a dynamic range, and adjust a focus of the camera. In addition, the vehicle control module 811 may turn on/off the operation of sensors individually or collectively.

In some embodiments, the vehicle control module 811 may be used to change parameters of the image pre-processor 805 in a method such as modifying a frequency range of filters, adjusting features and/or edge detection parameters for object detection, or adjusting channels and a bit depth, and the like. In various embodiments, the vehicle control module 811 may be used to control autonomous driving of the vehicle and/or a driver assistance function of the vehicle.

In some embodiments, the network interface 813 may be responsible for an internal interface between block configurations of the autonomous driving control system 800 and the communication unit 815. Specifically, the network interface 813 may be a communication interface for receiving and/or transmitting data including voice data. According to various embodiments, the network interface 813 may be connected to external servers to connect voice calls, receive and/or transmit text messages, transmit sensor data, update software of the vehicle with the autonomous driving system, or update software of the autonomous driving system of the vehicle, through the communication unit 815.

In various embodiments, the communication unit 815 may include various wireless interfaces of cellular or WiFi methods. For example, the network interface 813 may be used to receive an update on operating parameters and/or commands for the sensors 803, the image pre-processor 805, the deep learning network 807, the AI processor 809, and the vehicle control module 811 from an external server connected through the communication unit 815. For example, a machine learning model of the deep learning network 807 may be updated by using the communication unit 815. According to another example, the communication unit 815 may be used to update operating parameters of the image pre-processor 805, such as image processing parameters, and/or firmware of the sensors 803.

In another embodiment, the communication unit 815 may be used to activate communications for an emergency contact and emergency services in an accident or near-accident event. For example, in a crash event, the communication unit 815 may be used to call emergency services for assistance and may be used to externally notify emergency services of crash details and a location of the vehicle. In various embodiments, the communication unit 815 may update or obtain an expected arrival time and/or a destination location.

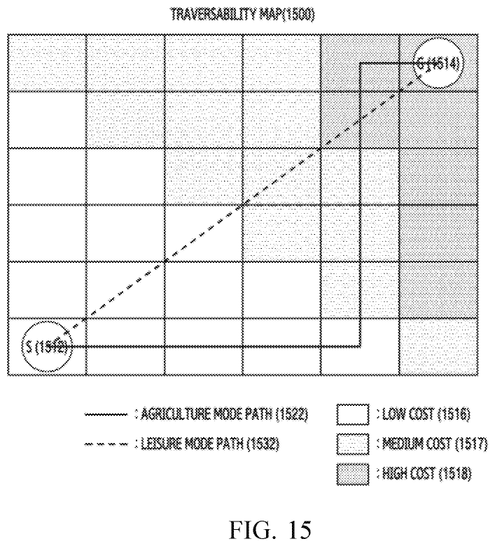

According to an embodiment, the autonomous driving system 800 illustrated in FIG. 15 may be configured with an electronic device 100 of the vehicle. According to an embodiment, when an autonomous driving release event occurs from a user during autonomous driving of the vehicle, the AI processor 809 of the autonomous driving system 800 may control the software of the vehicle autonomous driving to learn by controlling information related to the autonomous driving release event to be inputted as training set data of the deep learning network.

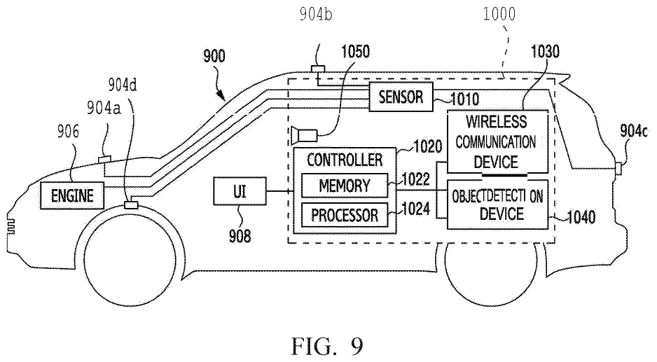

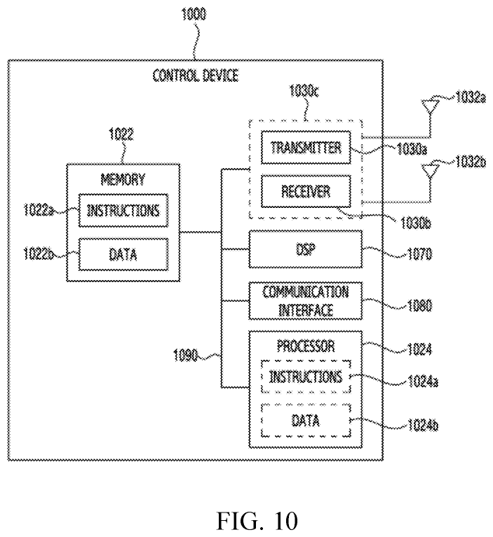

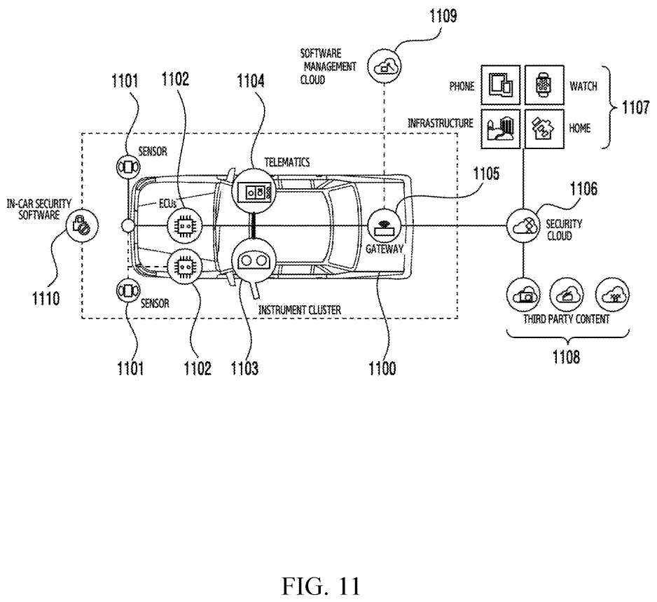

FIGS. 9 and 10 illustrate an example of a block diagram indicating an autonomous driving moving object according to an embodiment. FIG. 11 illustrates an example of a gateway related to a user device according to various embodiments.

Referring to FIG. 9, an autonomous moving object 900 according to the present embodiment may include a control device 1000, sensing modules 904a, 904b, 904c, and 904d, an engine 906, and a user interface 908.

The autonomous driving moving object 900 may have an autonomous driving mode or a manual mode. As an example, according to a user input received through the user interface 908, it may be switched from the manual mode to the autonomous driving mode or may be switched from the autonomous driving mode to the manual mode.

In case that the moving object 900 operates in the autonomous driving mode, the autonomous driving moving object 900 may operate under control of the control device 1000.

In the present embodiment, the control device 1000 may include a controller 1020, including memory 1022 and a processor 1024, a sensor 1010, a communication device 1030, and an object detection device 1040.

Herein, the object detection device 1040 may perform all or a portion of a function of a distance measurement device.

That is, in the present embodiment, the object detection device 1040 is a device for detecting an object located outside the moving object 900, and the object detection device 1040 may detect the object located outside the moving object 900 and generate object information according to the detection result.

The object information may include information on existence or nonexistence of the object, location information of the object, distance information between the moving object and the object, and relative speed information between the moving object and the object.

The object may include various objects located outside the moving object 900, such as a lane, another vehicle, a pedestrian, a traffic signal, light, a road, a structure, a speed bump, a landform, an animal, and the like. Herein, the traffic signal may be a concept including a traffic signal, a traffic sign, a pattern or text drawn on a road surface. In addition, the light may be light generated from a lamp equipped in another vehicle, light generated from a streetlamp, or sunlight.

In addition, the structure may be an object located around a road and fixed to the ground. For example, the structure may include a streetlamp, a street tree, a building, a power pole, a traffic light, and a bridge. The landform may include a mountain, a hill, and the like.

Such the object detection device 1040 may include a camera module. The controller 1020 may extract object information from an external image photographed by the camera module and enable the controller 1020 to process information thereon.

In addition, the object detection device 1040 may further include imaging devices for recognizing an external environment. RADAR, a GPS device, Odometry, and another computer vision device, an ultrasonic sensor, and an infrared sensor may be used, in addition to LIDAR, and these devices may be selected or operated simultaneously as needed to enable more precise detection.

Meanwhile, the distance measurement device according to an embodiment of the present invention may calculate a distance between the autonomous driving moving object 900 and the object, and may control an operation of the moving object based on the distance calculated in connection with the control device 1000 of the autonomous driving moving object 900.

As an example, in case that there is a probability of a collision according to the distance between the autonomous driving moving object 900 and the object, the autonomous driving moving object 900 may control a brake to lower a speed or stop. As another example, in case that the object is a moving object, the autonomous driving moving object 900 may control a traveling speed of the autonomous driving moving object 900 to maintain a predetermined distance or more from the object.

This distance measurement device according to an embodiment of the present invention may be configured as a module in the control device 1000 of the autonomous driving moving object 900. That is, the memory 1022 and the processor 1024 of the control device 1000 may be configured to implement a collision prevention method according to the present invention in software.

In addition, the sensor 1010 may obtain various sensing information by connecting an internal/external environment of the moving object with the sensing modules 904a, 904b, 904c, and 904d. Herein, the sensor 1010 may include a posture sensor (e.g., a yaw sensor), a roll sensor, a pitch sensor, a collision sensor, a wheel sensor, a speed sensor, a tilt sensor, a weight detection sensor, a heading sensor, a gyro sensor, a position module, a moving object forward/rearward sensor, a battery sensor, a fuel sensor, a tire sensor, a steering sensor by handle rotation, a moving object internal temperature sensor, a moving object internal humidity sensor, an ultrasonic sensor, an illumination sensor, an accelerator pedal position sensor, a brake pedal position sensor, and the like.

Accordingly, the sensor 1010 may obtain sensing signals for moving object posture information, moving object collision information, moving object direction information, moving object location information (GPS information), moving object angle information, moving object speed information, moving object acceleration information, moving object tilt information, moving object forward/rearward information, battery information, fuel information, tire information, moving object lamp information, and moving object internal temperature information, moving object internal humidity information, a steering wheel rotation angle, moving object external illumination, a pressure applied to an accelerator pedal, a pressure applied to a brake pedal, and the like.

In addition, the sensor 1010 may further include an accelerator pedal sensor, a pressure sensor, an engine speed sensor, an air flow sensor (AFS), an intake air temperature sensor (ATS), a water temperature sensor (WTS), a throttle position sensor (TPS), a TDC sensor, a crank angle sensor (CAS), and the like.

As such, the sensor 1010 may generate moving object state information based on sensing data.

The wireless communication device 1030 is configured to implement wireless communication between the autonomous driving moving object 900. For example, it enables the autonomous driving moving object 900 to communicate with a mobile phone of a user, or the other wireless communication device 1030, another moving object, a central device (a traffic control device), a server, and the like. The wireless communication device 1030 may transmit and receive a wireless signal according to an access wireless protocol. A wireless communication protocol may be Wi-Fi, Bluetooth, Long-Term Evolution (LTE), Code Division Multiple Access (CDMA), Wideband Code Division Multiple Access (WCDMA), Global Systems for Mobile Communications (GSM), but the communication protocol is not limited thereto.

In addition, in the present embodiment, it is also possible for the autonomous driving moving object 900 to implement communication between moving objects through the wireless communication device 1030. That is, the wireless communication device 1030 may perform communication with another moving object and other moving objects on the road through vehicle-to-vehicle (V2V) communication. The autonomous driving moving object 900 may transmit and receive information such as driving warning and traffic information through the vehicle-to-vehicle (V2V) communication, and it is also possible to request information from, or receive a request from the other moving object. For example, the wireless communication device 1030 may perform the V2V communication as a dedicated short-range communication (DSRC) device or a Cellular-V2V (C-V2V) device. In addition, besides the vehicle-to-vehicle (V2V) communication, communication (e.g., Vehicle to Everything communication (V2X)) between a vehicle and another object (e.g., an electronic device carried by a pedestrian, and the like) may also be implemented through the wireless communication device 1030.

In addition, the wireless communication device 1030 may obtain information generated from various mobilities, including infrastructure (a traffic light, a CCTV, a RSU, a eNode B, and the like) located on the road or other autonomous driving/non-autonomous driving vehicles, and the like, through a non-terrestrial network other than a terrestrial network, as information for autonomous driving performance of the autonomous driving moving object 900.

For example, the wireless communication device 1030 may perform wireless communication through a Low Earth Orbit (LEO) satellite system, a Medium Earth Orbit (MEO) satellite system, a Geostationary Orbit (GEO) satellite system, a High Altitude Platform (HAP) system, and the like, that configure a non-terrestrial network and an antenna dedicated to the non-terrestrial network mounted on the autonomous driving moving object 900.

For example, the wireless communication device 1030 may perform wireless communication with various platforms configuring the NTN according to a 5TH Generation New Radio Non-Terrestrial Network (5G NR NTN) standard, which is currently discussed in 3GPP, and the like, but is not limited thereto.

In the present embodiment, the controller 1020 may select a platform that may properly perform NTN communication in consideration of various information such as a location of the autonomous driving moving object 900, current time, and available power, and control the wireless communication device 1030 to perform wireless communication with the selected platform.

In the present embodiment, the controller 1020, which is a unit that controls an overall operation of each unit in the moving object 900, may be configured by a manufacturer of the moving object when manufacturing or may be additionally configured to perform a function of autonomous driving after manufacturing. In addition, a configuration for performing a continuous additional function may be included through an upgrade of the controller 1020 configured when manufacturing. This controller 1020 may also be named an Electronic Control Unit (ECU).

The controller 1020 may collect various data from the connected sensor 1010, the object detection device 1040, the communication device 1030, and may transmit a control signal to the sensor 1010, the engine 906, the user interface 908, the communication device 1030, and the object detection device 1040 included in other components in the moving object based on the collected data. In addition, although not illustrated, the control signal may also be transmitted to an acceleration device, a braking system, a steering device, or a navigation device related to traveling of the moving object.

In the present embodiment, the controller 1020 may control the engine 906, for example, may detects a speed limit of a road on which the autonomous driving moving object 900 is traveling, and may control the engine 906 so that a traveling speed does not exceed the speed limit or may control the engine 906 to accelerate the traveling speed of the autonomous driving moving object 900 in a range that does not exceed the speed limit.

In addition, when the autonomous driving moving object 900 approaches a lane or leaves the lane while the autonomous driving moving object 900 is traveling, the controller 1020 may determine whether such lane approaching and leaving are due to a normal traveling situation or another traveling situation, and may control the engine 906 to control the traveling of the moving object according to the determination result. Specifically, the autonomous driving moving object 900 may detect lanes formed on both sides of the lane in which the moving object is traveling. In this case, the controller 1020 may determine whether the autonomous driving moving object 900 approaches the lane or leaves the lane, and if it is determined that the autonomous driving moving object 900 approaches the lane or leaves the lane, the controller 1020 may determine whether this traveling is according to an accurate traveling situation or another traveling situation. Herein, as an example of the normal traveling situation, it may be a situation in which a lane change of the moving object is required. In addition, as an example of the other driving situations, it may be a situation in which a lane change of the moving object is not required. When it is determined that the autonomous driving moving object 900 is approaching the lane or leaving the lane in a situation in which the moving object does not need to change lane, the controller 1020 may control the traveling of the autonomous driving moving object 900 so that the autonomous driving moving object 900 does not leave the lane and normally travels in a corresponding vehicle.

In case that another moving object or an obstacle exists in a front of the moving object, it may control the engine 906 or the braking system to decelerate the driving moving object, and may control a trajectory, a traveling route, and a steering angle in addition to speed. Alternatively, the controller 1020 may control the traveling of the moving object by generating a necessary control signal according to recognition information of another external environment, such as a traveling lane or a driving signal of the moving object.

In addition to generating its own control signal, the controller 1020 may also control the traveling of the moving object by performing communication with a nearby moving object or a central server and transmitting a command to control peripheral devices through the received information.

In addition, since accurate recognition of the moving object or lane according to the present embodiment may be difficult in case that a location of the camera module 1050 changes or an angle of view changes, the controller 1020 may generate a control signal for controlling to perform calibration of the camera module 1050 to prevent this. Therefore, in the present embodiment, by generating the calibration control signal to the camera module 1050, the controller 1020 may continuously maintain a normal mounting location, a direction, an angle of view, and the like of the camera module 1050 even when a mounting location of the camera module 1050 is changed due to vibration or impact generated by a movement of the autonomous driving moving object 900. In case that an initial mounting location, a direction, and an angle of view information of the camera module 1050 that are pre-stored, and an initial mounting location, a direction, an angle of view information, and the like of the camera module 1050 measured while the autonomous driving moving object 800 is traveling are changed by a threshold value or more, the controller 1020 may generate the control signal to perform the calibration of the camera module 1050.

In the present embodiment, the controller 1020 may include the memory 1022 and the processor 1024. The processor 1024 may execute software stored in the memory 1022 according to the control signal of the controller 1020. Specifically, the controller 1020 may store data and commands for performing the lane detection method according to the present invention in the memory 1022, and the commands may be executed by the processor 1024 to implement one or more methods disclosed herein.

In this case, the memory 1022 may be stored in a recording medium executable by the non-volatile processor 1024. The memory 1022 may store software and data through an appropriate internal/external device. The memory 1022 may be configured with random access memory (RAM), read only memory (ROM), a hard disk, and a memory 1022 device connected with a dongle.

The memory 1022 may at least store an Operating system (OS), a user application, and executable commands. The memory 1022 may also store application data and array data structures.

The processor 1024, which is a microprocessor or an appropriate electronic processor, may be a controller, a microcontroller, or a state machine.

The processor 1024 may be implemented as a combination of computing devices, and the computing device may be configured with a digital signal processor, a microprocessor, or an appropriate combination thereof.

Meanwhile, the autonomous driving moving object 900 may further include the user interface 908 for a user input with respect to the above-described control device 1000. The user interface 908 may enable a user to input information with appropriate interaction. For example, it may be implemented as a touch screen, a keypad, or an operation button, and the like. The user interface 908 may transmit an input or a command to the controller 1020, and the controller 1020 may perform a control operation of the moving object in response to the input or the command.

In addition, the user interface 908, which is a device outside the autonomous driving moving object 900, may perform communication with the autonomous driving moving object 900 through the wireless communication device 1030. For example, the user interface 808 may be linkable with a mobile phone, a tablet, or another computer device.

Furthermore, in the present embodiment, the autonomous driving moving object 900 has been described as including the engine 906, but it may also include another type of a propulsion system. For example, the moving object may be operated with electrical energy, and may be operated through hydrogen energy or a hybrid system combining them. Therefore, the controller 1020 may include a propulsion mechanism according to the propulsion system of the autonomous driving moving object 900 and may provide a control signal according to this to components of each propulsion mechanism.

Hereinafter, a detailed configuration of the control device 1000 according to the present invention according to the present embodiment will be described in more detail with reference to FIG. 7.

A control device 1000 includes a processor 1024. The processor 1024 may be a general-purpose single or multi-chip microprocessor, a dedicated microprocessor, a microcontroller, a programmable gate array, and the like. The processor may be referred to as a central processing unit (CPU). In addition, in the present embodiment, it is possible that the processor 1024 is used as a combination of a plurality of processors.

The control device 1000 also includes memory 1022. The memory 1022 may be any electronic component capable of storing electronic information. The memory 1022 may also include a combination of the memories 1022 in addition to single memory.

Data and commands 1022a for performing a distance measuring method of a distance measuring device according to the present invention may be stored in the memory 1022. When the processor 1024 executes the commands 1022a, all or a portion of the commands 1022a and the data 1022b required for performing a command may be loaded 1024a and 1024b onto the processor 1024.

The control device 1000 may include a transmitter 1030a, a receiver 1030b, or a transceiver 1030c for permitting transmission and reception of signals. One or more antennas 1032a and 1032b may be electrically connected to the transmitter 1030a, the receiver 1030b, or each transceiver 1030c, and may further include antennas.

The control device 1000 may include a digital signal processor (DSP) 1070. Through the DSP 1070, the digital signal may be quickly processed by a moving object.

The control device 1000 may include a communication interface 1080. The communication interface 1080 may include one or more ports and/or communication modules for connecting other devices to the control device 1000. The communication interface 1080 may enable a user and the control device 1000 to interact with each other.

Various configurations of the control device 1000 may be connected together by one or more buses 1090, and the buses 1090 may include a power bus, a control signal bus, a state signal bus, a data bus, and the like. Under a control of the processor 1024, configurations may transmit mutual information through the bus 1090 and perform a desired function.

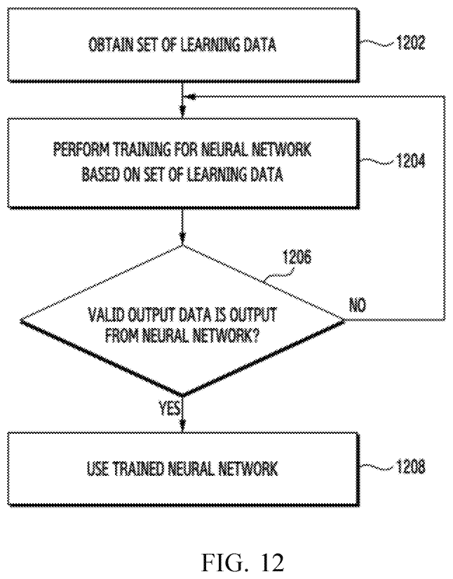

Meanwhile, in various embodiments, the control device 1000 may be related to a gateway for communication with a security cloud. For example, referring to FIG. 12, the control device 1000 may be related to a gateway 1105 for providing information obtained from at least one of components 901 to 1004 of a vehicle 1100 to a security cloud 1106. For example, the gateway 1105 may be included in the control device 1000. For another example, the gateway 1105 may be configured as a separate device in the vehicle 1100 that is distinguished from the control device 1000. The gateway 1105 connects a network in the vehicle 1100 secured by a software management cloud 1109, the security cloud 1106, and in-car security software 1110, having different networks, to enable communication.

For example, a component 1101 may be a sensor. For example, the sensor may be used to obtain information on at least one of a state of the vehicle 1100 or a state around the vehicle 1100. For example, the component 1101 may include a sensor 1010.

For example, a component 1102 may be electronic control units (ECUs). For example, the ECUs may be used for engine control, transmission control, airbag control, and tire pressure management.

For example, a component 1103 may be an instrument cluster. For example, the instrument cluster may mean a panel located in a front of a driver's seat among dashboards. For example, the instrument cluster may be configured to display information necessary for driving to a driver (or a passenger). For example, the instrument cluster may be used to display at least one of visual elements for indicating a revolutions per minute (or rotates per minute) (RPM) of the engine, visual elements for indicating a speed of the vehicle 1100, visual elements for indicating an amount of remaining fuel, visual elements for indicating a state of a gear, or visual elements for indicating information obtained through the component 1101.

For example, a component 1104 may be a telematics device. For example, the telematics device may mean a device that provides various mobile communication services, such as location information and safe driving in the vehicle 1100 by coupling wireless communication technology and global positioning system (GPS) technology. For example, the telematics device may be used to connect the vehicle 1100 with a driver, a cloud (e.g., the security cloud 1106), and/or a surrounding environment. For example, the telematics device may be configured to support high bandwidth and low latency for 5G NR-standard technology (e.g., V2X technology of the 5G NR, Non-Terrestrial Network (NTN) technology of the 5G NR). For example, the telematics device may be configured to support autonomous driving of the vehicle 1100.

For example, the gateway 1105 may be used to connect a network within the vehicle 1100, and the software management cloud 1109 and the secure cloud 1106, which are a network outside the vehicle. For example, the software management cloud 1109 may be used to update or manage at least one software necessary for traveling and managing the vehicle 1100. For example, the software management cloud 1109 may be linked to the in-car security software 1110 installed in the vehicle. For example, the in-car security software 1110 may be used to provide a security function in the vehicle 1100. For example, the in-car security software 1110 may encrypt data transmitted and received through an in-car network using an encryption key obtained from an external authorized server for encryption of the in-car network. In various embodiments, the encryption key used by the in-car security software 1110 may be generated corresponding to vehicle identification information (a vehicle license plate, a vehicle identification number (VIN)) or information (e.g., user identification information) uniquely assigned to each user.

In various embodiments, the gateway 1105 may transmit the data encrypted by the in-car security software 1110 based on the encryption key to the software management cloud 1109 and/or the security cloud 1106. The software management cloud 1109 and/or the security cloud 1106 may identify the data received from which vehicle or which user by decrypting the data encrypted by the encryption key of the in-car security software 1110. For example, since the decryption key is a unique key corresponding to the encryption key, the software management cloud 1109 and/or the security cloud 1106 may identify a transmission entity (e.g., the vehicle or the user) of the data based on the data decrypted through the decryption key.

For example, the gateway 1105 may be configured to support in-car security software 1110 and may be related to the control device 1000. For example, the gateway 1105 may be related to the control device 1000 to support a connection between a client device 1107 and the control device 1000 connected to the security cloud 1106. For another example, the gateway 1105 may be related to the control device 1000 to support a connection between a third-party cloud 1108 connected to the security cloud 1106 and the control device 1000. However, it is not limited thereto.

In various embodiments, the gateway 1105 may be used to connect the vehicle 1100 with the software management cloud 1109 to manage operating software of the vehicle 1100. For example, the software management cloud 1109 may monitor whether updating the operating software of the vehicle 1100 is required, and based on monitoring that the updating the operating software of the vehicle 1100 is required, provide data for the updating the operating software of the vehicle 1100 through the gateway 1105. For another example, the software management cloud 1109 may receive a user request for updating the operating software of the vehicle 1100 from the vehicle 1100 through the gateway 1105, and provide data for updating the operating software of the vehicle 1100 based on the reception. However, it is not limited thereto.

FIG. 12 is a diagram for explaining an operation of an electronic device for training a neural network based on a set of learning data, according to an embodiment.

An operation described with reference to FIG. 12 may be performed by the above-described electronic device (e.g., the electronic device 100 of FIG. 1).

Referring to FIG. 12, in operation 1202, the electronic device may obtain the set of the learning data according to an embodiment. The electronic device may obtain the set of the learning data for supervised learning. The learning data may include a pair of input data and ground truth data corresponding to the input data. The ground truth data may indicate output data to be obtained from the neural network that has received the input data, which is the pair of the ground truth data. The ground truth data may be obtained by the electronic device described above.

For example, in case of training the neural network for image recognition, the learning data may include information regarding an image and one or more subjects included within the image. The information may include a category (or a class) of a subject identifiable through the image. The information may include a location, a width, a height, and/or a size of a visual object corresponding to the subject within the image. The set of the learning data identified through the operation 1202 may include pairs of a plurality of learning data. In the example of training the neural network for the image recognition, the set of the learning data identified by the electronic device may include a plurality of images and ground truth data corresponding to each of the plurality of images.

In operation 1204, the electronic device according to an embodiment may perform training on the neural network based on the set of the learning data. In an embodiment in which the neural network is trained based on the supervised learning, the electronic device may input the input data included in the learning data to an input layer of the neural network. An example of the neural network including the input layer will be described with reference to FIG. 15. From an output layer of the neural network receiving the input data through the input layer, the electronic device may obtain output data of the neural network corresponding to the input data.

In an embodiment, the training of the operation 1204 may be performed based on a difference between the output data and the ground truth data included in the learning data and corresponding to the input data. For example, the electronic device may adjust one or more parameters related to the neural network to reduce the difference based on a gradient descent algorithm. An operation of the electronic device adjusting the one or more parameters may be referred to as tuning for the neural network. The electronic device may perform the tuning of the neural network based on the output data using a function defined to evaluate performance of the neural network, such as a cost function. The difference between the output data and the ground truth data may be included as an example of the cost function.

In operation 1206, according to an embodiment, the electronic device may identify whether valid output data is outputted from the neural network trained by the operation 1204. The output data being valid may mean that the difference (or the cost function) between the output data and the ground truth data satisfies a condition set for use of the neural network. For example, in case that an average value and/or the maximum value of the difference between the output data and the ground truth data is less than or equal to a designated threshold value, the electronic device may determine that the valid output data is outputted from the neural network.

In case that the valid output data is not outputted from the neural network (1206—NO), the electronic device may repeatedly perform training of the neural network based on the operation 1204. An embodiment is not limited thereto, and the electronic device may repeatedly perform the operations 1202 and 1204.

In a state in which the valid output data is obtained from the neural network (1206—YES), based on operation 1208, the electronic device according to an embodiment may use the trained neural network. For example, the electronic device may input other input data to the neural network that is distinct from the input data inputted to the neural network as the learning data. The electronic device may use output data obtained from the neural network receiving the other input data as a result of performing inference on the other input data based on the neural network.

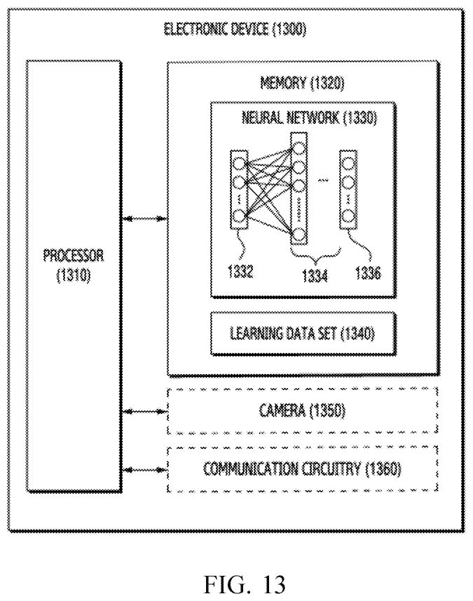

FIG. 13 is a block diagram of an electronic device according to an embodiment.

An electronic device 1300 of FIG. 13 may include the above-described electronic device.

For example, an operation described with reference to FIG. 12 may be performed by the electronic device 1300 of FIG. 13 and/or a processor 1310 of FIG. 13.

Referring to FIG. 13, the processor 1310 of the electronic device 1300 may perform computations related to a neural network 1330 stored in memory 1320. The processor 1310 may include at least one of a center processing unit (CPU), a graphic processing unit (GPU), and a neural processing unit (NPU). The NPU may be implemented as a chip separated from the CPU, or integrated into a chip such as the CPU in a form of a system on a chip (SoC). The NPU integrated into the CPU may be referred to as a neural core and/or an artificial intelligence (AI) accelerator.

The processor 1310 may identify the neural network 1330 stored in the memory 1320. The neural network 1330 may include a combination of an input layer 1332, one or more hidden layers 1334 (or intermediate layers), and an output layer 1336. The above-described layers (e.g., the input layer 1332, the one or more hidden layers 1334, and the output layer 1336) may include a plurality of nodes. The number of hidden layers 1334 may vary according to an embodiment, and the neural network 1330 including the plurality of hidden layers 1334 may be referred to as a deep neural network. An operation of training the deep neural network may be referred to as deep learning.

In an embodiment, in case that the neural network 1330 has a structure of a feed forward neural network, a first node included in a specific layer may be connected to all of second nodes included in another layer before the specific layer. In the memory 1320, parameters stored for the neural network 1330 may include weights assigned to connections between the second nodes and the first node. In the neural network 1330 having the structure of the feed forward neural network, a value of the first node may correspond to a weighted sum of values assigned to the second nodes, based on the weights assigned to the connections connecting the second nodes and the first node.

In an embodiment, in case that the neural network 1330 has a structure of a convolutional neural network, the first node included in the specific layer may correspond to a weighted sum of a portion of the second nodes included in the other layer before the specific layer. The portion of the second nodes corresponding to the first node may be identified by a filter corresponding to the specific layer. In the memory 1320, the parameters stored for the neural network 1330 may include weights indicating the filter. The filter may include, among the second nodes, one or more nodes to be used to calculate a weighted sum of the first node, and weights corresponding to each of the one or more nodes.

According to an embodiment, the processor 1310 of the electronic device 1300 may perform training on the neural network 1330 using a learning data set 1340 stored in the memory 1320. Based on the learning data set 1340, the processor 1310 may adjust one or more parameters stored in the memory 1320 for the neural network 1330 by performing the operation described with reference to FIG. 13.

According to an embodiment, the processor 1310 of the electronic device 1300 may perform object detection, object recognition, and/or object classification using the neural network 1330 trained based on the learning data set 1340. The processor 1310 may input an image (or a video) obtained through a camera 1350 into the input layer 1332 of the neural network 1330. Based on the input layer 1332 to which the image is inputted, the processor 1310 may obtain a set (e.g., the output data) of values of the nodes of the output layer 1336 by sequentially obtaining values of the nodes of the layers included in the neural network 1330. The output data may be used as a result of inferring information included in the image using the neural network 1330. An embodiment is not limited thereto, and the processor 1310 may input an image (or a video) obtained from an external electronic device connected to the electronic device 1300 through communication circuitry 1360 to the neural network 1330.

In an embodiment, the neural network 1330 trained to process an image may be used to identify a region corresponding to a subject within the image (object detection), and/or to identify a class of the subject represented within the image (object recognition and/or object classification). For example, the electronic device 1300 may segment the region corresponding to the subject within the image based on a quadrangle shape such as a bounding box, using the neural network 1330. For example, the electronic device 1300 may identify at least one class matching the subject among a plurality of designated classes using the neural network 1330.

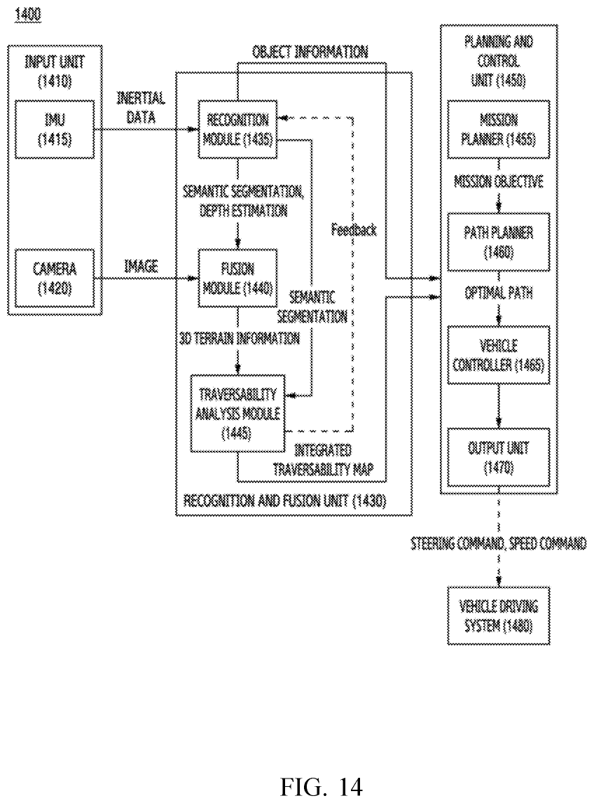

FIG. 14 is a functional block diagram of an autonomous driving system for planning a driving path using an object recognition result according to another embodiment of the present invention. An autonomous driving system 1400 illustrated in FIG. 14 may be implemented as being included in the electronic device 100 of FIG. 1, or may be implemented as a functional module embodied in the autonomous driving system 800 of FIG. 8.

Referring to FIG. 14, the autonomous driving system 1400 includes an input unit 1410, a recognition and fusion unit 1430, a planning and control unit 1450, an output unit 1470, and a vehicle driving system 1480. The input unit 1410 performs a role of collecting external environment information required for autonomous driving and state information of a vehicle. In the present embodiment, the input unit 1410 includes an inertial measurement unit (IMU) 1415 and a camera 1420.

The inertial measurement unit 1415 is a sensor that measures inertial information of a vehicle in real time, and is configured with a three-axis accelerometer and a three-axis gyroscope. The inertial measurement unit 1415 measures an acceleration and an angular velocity of the vehicle to generate inertial data, and then transmits it to the recognition and fusion unit 1430. The inertial data includes information such as a posture change (pitch, roll, yaw) of the vehicle, a moving speed, and the acceleration, and this is used to resolve a scale ambiguity of depth information estimated from a camera image subsequently and to correct an accumulated error.

The camera 1420 is a monocular camera that captures an unpaved road environment in front of the vehicle to obtain an image. The camera 1420 obtains the image of continuous frames and then transmits it to the recognition and fusion unit 1430. The present invention has an advantage in that accurate three-dimensional environment recognition is possible even only with a combination of the monocular camera 1420 and the inertial measurement unit 1415 that are low-cost, without a high-cost LiDAR or a stereo camera.

The recognition and fusion unit 1430 processes inertial data and an image received from the input unit 1410 to generate integrated information for an environment in which the vehicle is able to travel. The recognition and fusion unit 1430 includes a recognition module 1435, a fusion module 1440, and a traversability analysis module 1445.

The recognition module 1435 performs semantic segmentation and depth estimation on the image obtained from the camera 1420. The semantic segmentation may be performed using the first artificial intelligence model or the second artificial intelligence model described in FIG. 1 to FIG. 13, and classifies a class of an object for each pixel or region of the image. For example, various terrain elements and objects existing in an unpaved road environment such as a dirt road, grass, a tree, a rock, and a ditch are identified. The depth estimation is a process of estimating a relative distance to each pixel from a monocular image, and may be performed through a deep learning-based depth estimation network. The recognition module 1435 transmits a result of the semantic segmentation to the planning and control unit 1450 as object information, and then transmits a result of the depth estimation to the fusion module 1440.

The fusion module 1440 generates three-dimensional terrain information by tightly-coupled combining the depth information estimated from the recognition module 1435 and the inertial data received from the inertial measurement unit 1415. Specifically, using an Extended Kalman filter or a similar sensor fusion algorithm, a movement of the vehicle estimated through the inertial data and a visual change between image frames are fused. Through this, a scale ambiguity problem that is difficult to resolve only with the monocular camera is resolved, and a drift accumulated over time is corrected to generate accurate and consistent three-dimensional terrain information. The generated three-dimensional terrain information includes a three-dimensional coordinate and height information for a terrain in front of the vehicle, and this is transmitted to the traversability analysis module 1445.

The traversability analysis module 1445 generates an integrated traversability map by comprehensively using the three-dimensional terrain information generated from the fusion module 1440 and the semantic segmentation result of the recognition module 1435. The integrated traversability map is a two-dimensional map in which a space in front of the vehicle is divided into a grid form and a driving cost is assigned to each grid cell. The driving cost is calculated by comprehensively considering a type of a terrain, a slope, a roughness, and a negative obstacle. For example, a solid dirt road has a low cost, soft soil or mud has a medium cost, and a ditch or a pit having a risk that the vehicle is stuck has a very high cost. In addition, an additional cost may be assigned to a region having a steep slope or a region having a high roughness of the ground. The traversability analysis module 1445 transmits the generated integrated traversability map to the planning and control unit 1450. In addition, the traversability analysis module 1445 feeds back an analysis result to the recognition module 1435 through a feedback path indicated by a dotted line to dynamically improve an accuracy of the semantic segmentation.

The planning and control unit 1450 plans an optimal driving path based on the object information and the integrated traversability map received from the recognition and fusion unit 1430 and a mission objective (object information) input from outside, and generates a vehicle control command. The planning and control unit 1450 includes a mission planner 1455, a path planner 1460, and a vehicle controller 1465.

The mission planner 1455 receives a mission objective from a user or an external system. The mission objective represents a goal or a priority of driving to be performed by the vehicle, and for example, may be an agriculture mode, a military mode, a leisure mode, or a golf cart mode, and the like. The agriculture mode aims to minimize soil compaction of a farmland, the military mode aims to maintain formation in an extreme terrain, and the leisure mode may aim to prioritize ride comfort of an occupant. The mission planner 1455 dynamically sets a weight of a cost function to be considered during path planning according to the input mission objective and transmits the weight to the path planner 1460. The mission objective is input to the mission planner 1455 through an arrow indicated by a dotted line.

The path planner 1460 plans an optimal path by using the integrated traversability map received from the traversability analysis module 1445 and the weight of the cost function received from the mission planner 1455. The path planner 1460 searches for a path having the lowest accumulated cost among paths from a current position to a goal point by using an A* algorithm, a Rapidly-exploring Random Tree Star (RRT*) algorithm, or a similar graph search algorithm. At this time, even in the same terrain, a selected path may be different according to a mission objective. For example, in the agriculture mode, the path that minimizes soil compaction is preferentially selected, and in the leisure mode, a smooth path having good ride comfort is preferentially selected. The path planner 1460 transmits the planned optimal path to the vehicle controller 1465.

The vehicle controller 1465 generates a steering command and a speed command such that the vehicle travels along the optimal path generated by the path planner 1460. The steering command is a command for controlling a steering angle of the vehicle, and the speed command is a command for controlling acceleration or deceleration of the vehicle. The vehicle controller 1465 may generate a control command such that the vehicle accurately follows the planned path by using a proportional-integral-derivative (PID) controller, a model predictive control (MPC) controller, or a similar control algorithm. The steering command and speed command that are generated, are transmitted to an output unit 1470.

The output unit 1470 transmits the steering command and the speed command received from the vehicle controller 1465 to the vehicle driving system 1480. The output unit 1470 may convert the control command into an appropriate electrical signal or a communication protocol and transmit it in a form that the vehicle driving system 1480 is able to understand.

The vehicle driving system 1480 controls an actual steering angle and a speed of the vehicle according to the steering command and the speed command received from the output unit 1470. The vehicle driving system 1480 includes a steering actuator, a driving motor, and a brake system, and controls them to cause the vehicle to travel in a desired direction and at a desired speed.

As described above, the autonomous driving system 1400 illustrated in FIG. 14 may perform accurate recognition and fusion for the unpaved road environment by using the inertial measurement unit 1415 and the monocular camera 1420, which are a low-cost sensor combination, and may control the vehicle safely and efficiently by planning the driving path dynamically optimized according to the mission objective.

FIG. 15 is a conceptual diagram illustrating a process in which different optimal paths are generated according to a mission objective even when the same start point and the same goal point are provided on the same traversability map according to an embodiment of the present invention.

Referring to FIG. 15, a traversability map 1500 is a two-dimensional map representing a space in front of a vehicle in a grid form. Each grid cell of the traversability map 1500 is distinguished and displayed in different patterns according to a driving cost. The driving cost is a value calculated by comprehensively considering a type of a terrain, a slope, a roughness, and a negative obstacle by the traversability analysis module 1445 described in FIG. 14.

In the traversability map 1500, a low cost region 1516 is displayed as an empty space without a pattern. The low cost region 1516 represents a terrain most suitable for driving, and corresponds to, for example, a solid dirt road, a flat ground, or a region without an obstacle. A medium cost region 1517 is displayed in a diagonal pattern, and represents a terrain in which driving is possible but a driving cost is higher than that of the low cost region 1516. The medium cost region 1517 may correspond to, for example, somewhat soft soil, a gentle slope, or a grass field having a low roughness. A high cost region 1518 is displayed in a grid pattern, and represents a terrain in which driving is difficult or impossible. The high cost region 1518 corresponds to, for example, a region having a low driving stability such as a ditch or a pit having a risk that the vehicle is stuck, an obstacle such as a steep slope or a rock, or mud.

In the traversability map 1500, a start point S 1512 and a goal point G 1514 of the vehicle are displayed. The start point 1512 is positioned at a lower left of the traversability map 1500, and the goal point 1514 is positioned at an upper right. The vehicle starts from the start point 1512 and should reach the goal point 1514.

An agriculture mode path 1522 is a path displayed as a solid line, and is an optimal path generated by a path planner 1460 when an agriculture mode is selected in a mission planner 1455. A mission objective of the agriculture mode is to minimize soil compaction of a farmland. To this end, the mission planner 1455 sets a weight of a cost element related to the soil compaction to be high in a cost function. For example, the weight is adjusted to prefer a solid ground and to avoid soft soil. As a result, the path planner 1460 generates the agriculture mode path 1522 that passes through the low cost region 1516 as much as possible to minimize the soil compaction, even though the medium cost region 1517 or the high cost region 1518 is bypassed on the traversability map 1500. As illustrated in FIG. 15, the agriculture mode path 1522 starts from the start point 1512, first moves to a right, then passes through a lower portion along the low cost region 1516, ascends along a right edge, and heads toward the goal point 1514. This path minimizes the soil compaction by preferentially selecting the low cost region 1516, which is the solid ground, even though a distance is somewhat long.

A leisure mode path 1532 is a path displayed as a dotted line, and is an optimal path generated by the path planner 1460 when a leisure mode is selected in the mission planner 1455. A mission objective of the leisure mode is to prioritize ride comfort of a driver or an occupant. For this, the mission planner 1455 sets a weight of a cost element related to the ride comfort to be high in the cost function. For example, the weight is adjusted to minimize roughness of the ground, vibration, and abrupt direction change. As a result, the path planner 1460 selects a path in which an overall roughness or vibration of a driving path is lowest and is smoothest, even though a portion of the medium cost region 1517 is passed through. As illustrated in FIG. 15, the leisure mode path 1532 moves from the start point 1512 toward the goal point 1514 in a diagonal direction close to the shortest distance. This path partially passes through the medium cost region 1517, but provides a smooth path closest to a straight line overall, thereby maximizing the ride comfort. The leisure mode path 1532 is a path clearly distinguished from the agriculture mode path 1522.

As described above, FIG. 15 shows that different driving paths 1522 and 1532 optimized for respective situations are able to be generated by dynamically adjusting a cost function according to a mission objective of a user even for the same terrain environment and the same start point 1512 and the goal point 1514. The agriculture mode path 1522 is a path that prefers the solid ground by prioritizing minimization of the soil compaction, and the leisure mode path 1532 is a path that prefers the shortest distance and smooth driving by prioritizing the ride comfort. The present invention provides a high level of adaptability and generality compared to an autonomous driving system using a fixed cost function through such mission objective-based dynamic path planning.

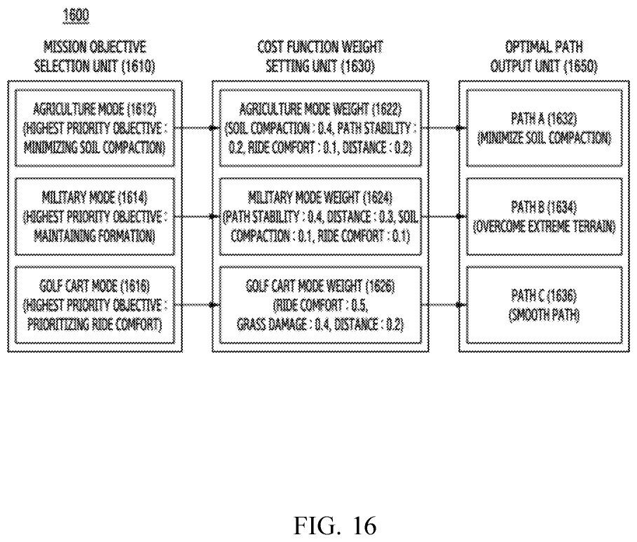

FIG. 16 is a conceptual diagram for more specifically describing an operation of the mission planner and the path planner illustrated in FIG. 14. FIG. 16 includes a mission objective selection unit 1610, a cost function weight setting unit 1630, and an optimal path output unit 1650. The mission objective selection unit 1610 and the cost function weight setting unit 1630 correspond to the mission planner 1455 of FIG. 14, and the optimal path output unit 1650 corresponds to an output of the path planner 1460 of FIG. 14.

Referring to FIG. 16, the mission objective selection unit 1610 receives a mission objective from a user or an external system. The mission objective selection unit 1610 provides various mission modes selectable by the user. For example, the mission objective selection unit 1610 includes an agriculture mode 1612, a military mode 1614, and a golf cart mode 1616. Each mission mode has a unique highest priority objective.

The agriculture mode 1612 has, as a highest priority objective, minimizing soil compaction when a vehicle travels on a farmland. In an agricultural environment, it is important to reduce a negative effect on growth of crops, by minimizing compaction of soil in which the crops are cultivated. Therefore, when the agriculture mode 1612 is selected, a path that prefers a solid ground and avoids soft soil is generated.

The military mode 1614 has, as a highest priority objective, maintaining a vehicle formation in a military operation environment. Military vehicles often move in formation with multiple vehicles, and should travel stably while maintaining the formation even in an extreme terrain. Therefore, when the military mode 1614 is selected, stability of a path and maintenance of the formation are importantly considered.

The golf cart mode 1616 has, as a highest priority objective, prioritizing ride comfort of an occupant in a leisure environment such as a golf course. A golf cart mainly travels on flat grass and should provide a smooth and comfortable driving experience to the occupant. Therefore, when the golf cart mode 1616 is selected, the ride comfort and minimization of grass damage are importantly considered.

The cost function weight setting unit 1630 dynamically sets a weight for each cost element of a cost function to be used during path planning according to the mission objective selected in the mission objective selection unit 1610. The cost function is used to calculate a total cost of a path on a traversability map 1500, and is represented as a weighted sum of a plurality of cost elements. The cost elements may include, for example, soil compaction, path stability, ride comfort, a distance, and grass damage.

When the agriculture mode 1612 is selected, the cost function weight setting unit 1630 sets an agriculture mode weight 1622. In the agriculture mode weight 1622, a weight for the soil compaction is set to 0.4 as a highest value, such that minimizing the soil compaction is considered with a highest priority. In addition, a weight for the path stability is set to 0.2 such that maintaining accuracy of a crop row is considered, a weight for the ride comfort is set to 0.1 as a low value, and a weight for the distance is set to 0.2. According to such weight setting, in the agriculture mode, a path that minimizes the soil compaction is preferentially selected.

When the military mode 1614 is selected, the cost function weight setting unit 1630 sets a military mode weight 1624. In the military mode weight 1624, a weight for the path stability is set to 0.4 as a highest value, such that a path in which stable driving is possible even in the extreme terrain is preferentially selected. A weight for the distance is set to 0.3 such that a path length for maintaining a formation is importantly considered, and a weight for the soil compaction and a weight for the ride comfort are set to 0.1, respectively, as low values. According to such weight setting, in the military mode, a path that is able to maintain the formation while overcoming the extreme terrain is preferentially selected.

When the golf cart mode 1616 is selected, the cost function weight setting unit 1630 sets a golf cart mode weight 1626. In the golf cart mode weight 1626, a weight for the ride comfort is set to 0.5 as a highest value, such that providing a smooth and comfortable driving experience to the occupant is considered with a highest priority. In addition, a weight for the grass damage is set to 0.4 as a high value such that protecting grass of a golf course is importantly considered, and a weight for the distance is set to 0.2. According to such weight setting, in the golf cart mode, a path that minimizes the grass damage and ensures the smooth driving is preferentially selected.

The weights are example values, and may be adjusted according to an actual driving environment or a preference of a user. An important point is that, by applying weights differently according to a mission objective for the same cost elements, path planning optimized for each mission situation is possible.

The optimal path output unit 1650 searches for an optimal path on a traversability map by applying a weight of a cost function set in the cost function weight setting unit 1630, and outputs a result. The optimal path output unit 1650 corresponds to the output of the path planner 1460 of FIG. 14. The optimal path is determined as a path having a lowest total cost obtained by applying weights to costs of respective grid cells.

When the agriculture mode weight 1622 is applied, the optimal path output unit 1650 generates a path A 1632 that minimizes the soil compaction. The path A 1632 preferentially passes through a low cost region that is the solid ground to minimize the soil compaction.

When the military mode weight 1624 is applied, the optimal path output unit 1650 generates a path B 1634 that overcomes the extreme terrain and maintains the formation. The path B 1634 selects a path in which stable driving is possible even in a rough terrain by preferentially considering stability of the path.

When the golf cart mode weight 1626 is applied, the optimal path output unit 1650 generates a path C 1636 that minimizes the grass damage and ensures the smooth driving. The path C 1636 selects a smooth path in which the ride comfort is best and an influence on the grass is minimized.

As described above, FIG. 16 shows that different optimal paths are able to be generated by applying weights differently according to a mission objective for the same cost elements. The present invention enables general-purpose path planning that satisfies various requirements with one system by differently combining weights for a plurality of predefined cost elements in real time according to the mission objective. This provides a high level of adaptability and flexibility compared to an autonomous driving system using a fixed cost function.

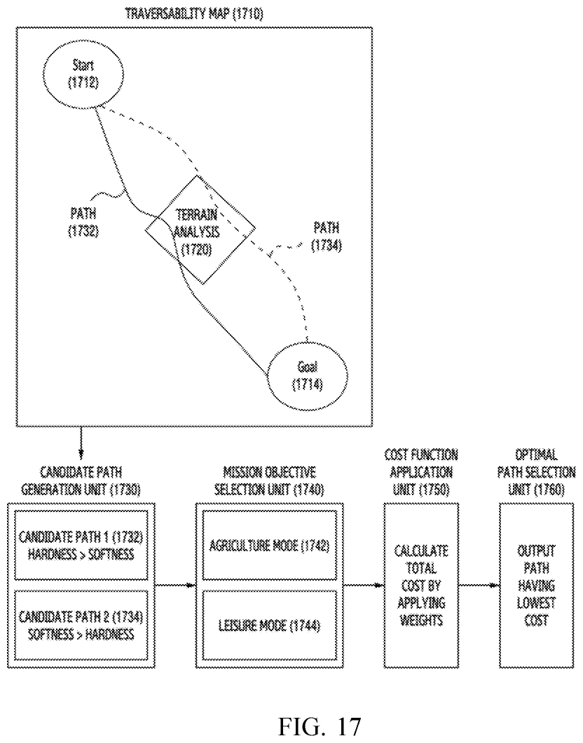

FIG. 17 is a flowchart illustrating a flow of an optimal path generation algorithm according to an embodiment of the present invention. FIG. 17 shows an entire process step by step until a final optimal path is selected from a traversability map 1710.

Referring to FIG. 17, an optimal path generation algorithm includes the traversability map 1710, a candidate path generation unit 1730, a mission objective selection unit 1740, a cost function application unit 1750, and an optimal path selection unit 1760.

The traversability map 1710 corresponds to an integrated traversability map generated by the traversability analysis module 1445 of FIG. 14. The traversability map 1710 represents a terrain in front of a vehicle in a grid form, and each grid cell has a driving cost obtained by comprehensively considering a type of a terrain, a slope, a roughness, and a negative obstacle. On the traversability map 1710, a start point 1712 and a goal point 1714 of the vehicle are set. The start point 1712 represents a current position of the vehicle, and the goal point 1714 represents a final destination that the vehicle should reach.

A terrain analysis 1720 is a step of analyzing possible paths between the start point 1712 and the goal point 1714 on the traversability map 1710. The terrain analysis 1720 analyzes characteristics of various paths that are able to reach from the start point 1712 to the goal point 1714 based on cost information of the traversability map 1710. The analysis identifies characteristics of a terrain through which each path passes and transmits them to the candidate path generation unit 1730.

The candidate path generation unit 1730 generates a plurality of candidate paths based on a result of the terrain analysis 1720. Each candidate path has a unique cost profile according to a characteristic of a terrain. In FIG. 17, two representative candidate paths are illustrated.

A candidate path 1 1732 is a path having a cost profile of “hardness>softness”. This means that the path mainly passes through a solid ground and includes more solid terrain than a soft terrain. The candidate path 1 1732 may be suitable for a mission that minimizes soil compaction or prioritizes stability of the vehicle.

A candidate path 2 1734 is a path having a cost profile of “softness>hardness”. This means that the path mainly passes through the soft terrain and includes more soft terrain than the solid terrain. The candidate path 2 1734 may be suitable for a mission that prioritizes ride comfort or considers smoothness of the path as important.

In practice, a plurality of such candidate paths may be generated, and each candidate path has a unique cost profile according to various characteristics such as hardness, softness, a slope, a roughness, and a distance.

The mission objective selection unit 1740 receives a mission objective from a user or an external system. The mission objective selection unit 1740 corresponds to the mission objective selection unit 1610 of FIG. 16. In FIG. 17, an agriculture mode 1742 and a leisure mode 1744 are illustrated.

The agriculture mode 1742 has, as a highest priority objective, minimizing the soil compaction. When the agriculture mode 1742 is selected, a weight of a cost function that prefers a solid ground is set.

The leisure mode 1744 has, as a highest priority objective, prioritizing the ride comfort of the occupant. When the leisure mode 1744 is selected, a weight of a cost function that prefers a smooth and flat path is set.

The cost function application unit 1750 calculates a total cost by applying a weight set according to the mission objective selected in the mission objective selection unit 1740 to a cost profile of each candidate path. The cost function application unit 1750 calculates a total cost of each candidate path by using the weight set in the cost function weight setting unit 1630 of FIG. 16.

For example, when the agriculture mode 1742 is selected, since a weight for the soil compaction is set to be high, a total cost of the candidate path 1 1732 including a large amount of solid ground is calculated to be relatively low. On the other hand, when the leisure mode 1744 is selected, since a weight for the ride comfort is set to be high, a total cost of the candidate path 2 1734 including a large amount of soft terrain is calculated to be relatively low.

The cost function application unit 1750 may calculate a total cost for each candidate path by using the following equation. Total Cost=w1×Soil Compaction Cost+w2 xPath Stability Cost+w3×Ride Comfort Cost+w4×Distance Cost+ . . . Herein, w1, w2, w3, and w4 are weights set according to the mission objective. As described above, even for the same candidate path, since the weights are different according to the mission objective, the total cost is different.

The optimal path selection unit 1760 compares the total costs calculated in the cost function application unit 1750 and selects and outputs a path having the lowest total cost as a final optimal path. The optimal path selection unit 1760 corresponds to the output of the path planner 1460 of FIG. 14.

For example, when the agriculture mode 1742 is selected, since the candidate path 1 1732 including the large amount of solid ground has the lowest cost, the candidate path 1 1732 is selected as an optimal path. On the other hand, when the leisure mode 1744 is selected, since the candidate path 2 1734 including the large amount of soft terrain has the lowest cost, the candidate path 2 1734 is selected as an optimal path.

The optimal path selection unit 1760 transmits the selected optimal path to the vehicle controller 1465 of FIG. 14, and the vehicle controller 1465 generates a steering command and a speed command for causing the vehicle to travel along this path.

As described above, FIG. 17 clearly shows an entire flow of an algorithm in which the plurality of candidate paths 1732 and 1734 are generated through the terrain analysis 1720, and the optimal path 1760 is selected by applying the cost function 1750 according to the mission objective 1742 and 1744. The present invention provides an intelligent path planning capability that is able to flexibly select an optimal path according to the mission objective even for the same traversability map and the same candidate paths through such dynamic cost function application.

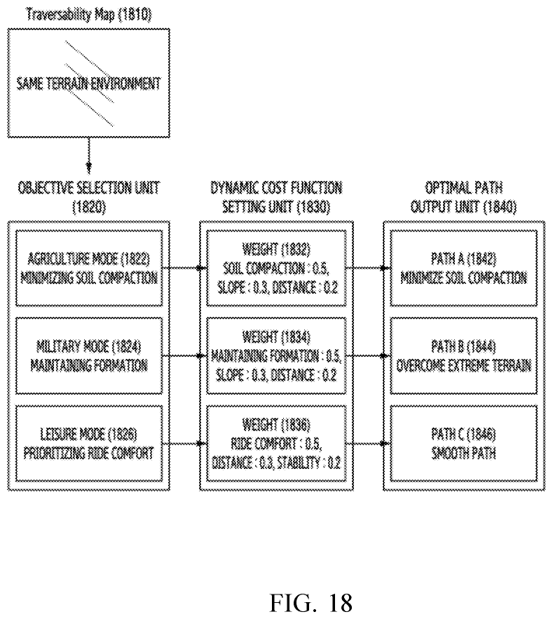

FIG. 18 is a conceptual diagram comprehensively illustrating a process in which different optimal paths are generated by applying a dynamic cost function according to a mission objective even when the same terrain environment is input according to an embodiment of the present invention. FIG. 18 presents an entire flow of the path planning process for each mission objective described in FIG. 14 to FIG. 17 as one integrated view.

Referring to FIG. 18, an entire system includes a traversability map 1810, a mission objective selection unit 1820, a dynamic cost function setting unit 1830, and an optimal path output unit 1840.

The traversability map 1810 corresponds to an integrated traversability map generated by the traversability analysis module 1445 of FIG. 14. The traversability map 1810 represents terrain information of an unpaved road environment in a grid form and indicates the same terrain environment. At an upper left of the traversability map 1810, lines in a diagonal direction are displayed to visually indicate characteristics of a terrain. The map is input data commonly used for three different mission objectives.

The mission objective selection unit 1820 receives a mission objective from a user or an external system. The mission objective selection unit 1820 corresponds to the mission planner 1455 of FIG. 14 and the mission objective selection unit 1610 of FIG. 16. In FIG. 18, three representative mission modes are illustrated.

An agriculture mode 1822 has minimizing soil compaction as a highest priority objective. When a vehicle travels in an agricultural environment, it is important to reduce a negative effect on crop growth by minimizing compaction of soil in which crops are cultivated. When the agriculture mode 1822 is selected, a weight corresponding thereto is transmitted to the dynamic cost function setting unit 1830.

A military mode 1824 has maintaining a formation as a highest priority objective. In a military operation environment, a plurality of vehicles move while forming the formation, and should travel stably while maintaining the formation even in an extreme terrain. When the military mode 1824 is selected, a weight corresponding thereto is transmitted to the dynamic cost function setting unit 1830.

A leisure mode 1826 has prioritizing ride comfort as a highest priority objective. In a leisure environment, providing a smooth and comfortable driving experience to an occupant is most important. When the leisure mode 1826 is selected, a weight corresponding thereto is transmitted to the dynamic cost function setting unit 1830.

The dynamic cost function setting unit 1830 dynamically sets weights for respective cost elements of a cost function according to the mission objective selected by the mission objective selection unit 1820. The dynamic cost function setting unit 1830 corresponds to the mission planner 1455 of FIG. 14 and the cost function weight setting unit 1630 of FIG. 16. In FIG. 18, specific weight values for three mission modes are illustrated.

A weight 1832 is a cost function weight corresponding to the agriculture mode 1822. In the weight 1832, a weight for the soil compaction is set to 0.5 as a highest value, such that minimizing the soil compaction is considered with a highest priority. In addition, a weight for a slope is set to 0.3 such that the slope of the terrain is importantly considered, and a weight for a distance is set to 0.2. According to such weight setting, in the agriculture mode, a path in which the slope is gentle while minimizing the soil compaction is preferentially selected.

A weight 1834 is a cost function weight corresponding to the military mode 1824. In the weight 1834, a weight for maintaining the formation is set to 0.5 as a highest value, such that maintaining the vehicle formation is considered with a highest priority. In addition, a weight for the distance is set to 0.3 such that a path length for maintaining the formation is importantly considered, and a weight for the slope is set to 0.2. According to such weight setting, in the military mode, a stable path that is able to maintain the formation even in the extreme terrain is preferentially selected.

A weight 1836 is a cost function weight corresponding to the leisure mode 1826. In the weight 1836, a weight for the ride comfort is set to 0.5 as a highest value, such that the ride comfort of the occupant is considered with a highest priority. In addition, a weight for the distance is set to 0.3, and a weight for stability is set to 0.2. According to such weight setting, in the leisure mode, a path that provides a smooth and comfortable driving is preferentially selected.

The optimal path output unit 1840 outputs an optimal path calculated by applying weights set by the dynamic cost function setting unit 1830. The optimal path output unit 1840 corresponds to the path planner 1460 of FIG. 14 and the optimal path output unit 1650 of FIG. 16. In FIG. 18, different optimal paths for three mission modes are illustrated.

A path A 1842 is an optimal path corresponding to the agriculture mode 1822, and is a path that minimizes the soil compaction. The weight 1832 is applied, such that a path that preferentially passes through a solid ground having low soil compaction is selected. The path A 1842 minimizes an effect on the crop growth in a farmland by minimizing the soil compaction.

A path B 1844 is an optimal path corresponding to the military mode 1824, and is a path that overcomes the extreme terrain. The weight 1834 is applied, such that a path that is able to maintain the formation and has the high stability of the path is selected. The path B 1844 provides a path that is able to travel stably while maintaining the vehicle formation even in a rough terrain.

A path C 1846 is an optimal path corresponding to the leisure mode 1826, and is a smooth path. The weight 1836 is applied, such that a smooth path having best ride comfort and low roughness of the ground is selected. The path C 1846 provides a pleasant and comfortable driving experience to the occupant.

As described above, FIG. 18 comprehensively shows a process in which, even though the same traversability map 1810 is input, different dynamic cost functions are respectively applied according to the selected mission objective, and as a result, different optimal paths are generated. The present invention implements a high-level intelligent autonomous driving that goes beyond simple obstacle avoidance and understands the context of a given mission and actively finds an optimal solution most suitable thereto, through such a dynamic cost function mechanism. This provides a general-purpose and adaptive path planning capability that is able to satisfy requirements of various application fields with one system.

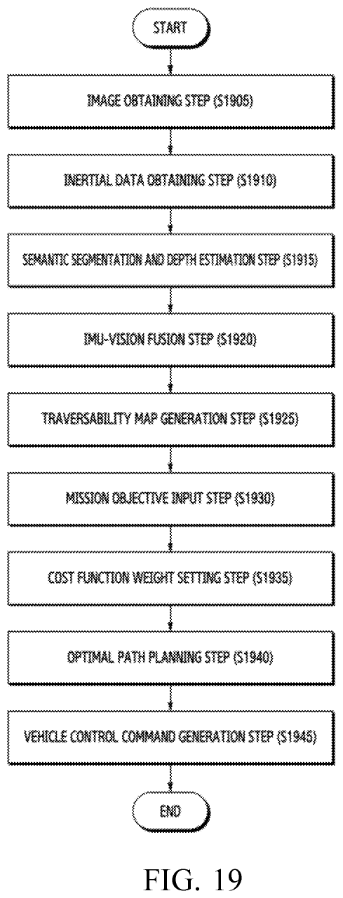

FIG. 19 is a flowchart illustrating a flow of a method for planning an autonomous driving path on an unpaved road according to an embodiment of the present invention. FIG. 19 shows, in detail, an operation of the autonomous driving system 1400 described in FIG. 14 step by step from a perspective of a method.

Referring to FIG. 19, the method for planning the autonomous driving path on the unpaved road starts from a start step and proceeds to an end step through an image obtaining step S1905, an inertial data obtaining step S1910, a semantic segmentation and depth estimation step S1915, an IMU-Vision fusion step S1920, a traversability map generation step S1925, a mission objective input step S1930, a cost function weight setting step S1935, an optimal path planning step S1940, and a vehicle control command generation step S1945.

The image obtaining step S1905 is a step of obtaining an image by capturing an unpaved road environment in front of a vehicle through a monocular camera mounted on the vehicle. The image obtaining step S1905 corresponds to an operation performed by the camera 1420 of FIG. 14. The obtained image includes a terrain, an obstacle, and an object of the unpaved road, and is used as basic input data for environment recognition in a subsequent step. The image may be obtained as continuous frames, and is collected at a constant frame rate for real-time processing.

The inertial data obtaining step S1910 is a step of obtaining inertial data of the vehicle through an inertial measurement unit (IMU) mounted on the vehicle. The inertial data obtaining step S1910 corresponds to an operation performed by the inertial measurement unit 1415 of FIG. 14. The obtained inertial data includes a 3-axis acceleration and a 3-axis angular velocity of the vehicle, and through this, information such as a posture change, a moving speed, and an acceleration of the vehicle may be identified in real time. The inertial data is collected in synchronization with the image obtaining step S1905, and is combined with image information in a subsequent fusion step.

The semantic segmentation and the depth estimation step S1915 is a step of performing semantic segmentation and depth estimation on an image obtained in an image obtaining step S1905. The semantic segmentation and the depth estimation step S1915 corresponds to an operation performed by the recognition module 1435 of FIG. 14. The semantic segmentation may be performed by using the first artificial intelligence model or the second artificial intelligence model described in FIG. 1 to FIG. 13, and classifies a class of an object for each pixel or region of the image. For example, various terrain elements and objects existing in the unpaved road environment, such as a dirt road, grass, a tree, a rock, and a ditch, are identified. The depth estimation is a process of estimating a relative distance to each pixel from a monocular image, and may be performed through a deep learning-based depth estimation network. A result of the semantic segmentation and a result of the depth estimation are transmitted to a subsequent step as object information and depth information, respectively.

The IMU-Vision fusion step S1920 is a step of generating three-dimensional terrain information by tightly coupling the inertial data obtained in the inertial data obtaining step S1910 and the depth information estimated in the semantic segmentation and the depth estimation step S1915. The IMU-Vision fusion step S1920 corresponds to an operation performed by the fusion module 1440 of FIG. 14. In this step, a movement of the vehicle estimated through the inertial data and a visual change between image frames are fused by using an extended Kalman filter (EKF) or a similar sensor fusion algorithm. Through this, a scale ambiguity problem that is difficult to solve only with the monocular camera is solved, and a travel distance error that is accumulated over time is corrected, thereby generating accurate and consistent three-dimensional terrain information. The generated three-dimensional terrain information includes three-dimensional coordinates and height information for the terrain in front of the vehicle.

The traversability map generation step S1925 is a step of generating an integrated traversability map by comprehensively using the three-dimensional terrain information generated in the IMU-Vision fusion step S1920 and the semantic segmentation result obtained in the semantic segmentation and the depth estimation step S1915. The traversability map generation step S1925 corresponds to an operation performed by the traversability analysis module 1445 of FIG. 14. The integrated traversability map is a two-dimensional map in which a space in front of the vehicle is divided in a grid form and a travel cost is assigned to each grid cell. The travel cost is calculated by comprehensively considering a type of terrain, a slope, a roughness, and a negative obstacle. For example, a solid dirt road has a low cost, soft soil or mud has a medium cost, and a ditch or a pit having a risk that the vehicle is stuck has a very high cost. The generated traversability map may be represented in a form such as the traversability map 1500 of FIG. 15.

The mission objective input step S1930 is a step of receiving the mission objective from the user or the external system. The mission objective input step S1930 corresponds to an operation performed by the mission planner 1455 of FIG. 14 and the mission objective selection unit 1610 of FIG. 16. The mission objective represents a goal or a priority of driving that the vehicle has to perform, and may be, for example, an agriculture mode, a military mode, a leisure mode, or a golf cart mode. The user may select the mission objective through an interface of the vehicle, or the mission objective may be automatically set from the external system. The input mission objective is used to dynamically set cost function weights in a subsequent step.

The cost function weight setting step S1935 is a step of dynamically setting weights for respective cost elements of a cost function to be used for path planning according to the mission objective input in the mission objective input step S1930. The cost function weight setting step S1935 corresponds to an operation performed by the mission planner 1455 of FIG. 14 and the cost function weight setting unit 1630 of FIG. 16. The cost function includes various cost elements such as soil compaction, path stability, ride comfort, a distance, and grass damage, and weights for respective cost elements are differently set according to the mission objective. For example, when the agriculture mode is selected, a weight for the soil compaction is set to be high, and when the leisure mode is selected, a weight for the ride comfort is set to be high. The set weight is used to plan an optimal path in a subsequent step.

The optimal path planning step S1940 is a step of planning an optimal path by using the integrated traversability map generated in the traversability map generation step S1925 and the cost function weights set in the cost function weight setting step S1935. The optimal path planning step S1940 corresponds to an operation performed by the path planner 1460 of FIG. 14. In this step, a path having the lowest accumulated cost among paths from a current position to a goal point is searched by using an A* algorithm, a Rapidly-exploring Random Tree Star (RRT*) algorithm, or a similar graph search algorithm. Since the cost function weights are dynamically set according to the mission objective, even for the same traversability map, different optimal paths may be generated according to the mission objective. For example, in the agriculture mode, a path that minimizes the soil compaction is selected as an optimal path, and in the leisure mode, a smooth path having good ride comfort is selected as an optimal path. The planned optimal path is transmitted to the vehicle control command generation step.

The vehicle control command generation step S1945 is a step of generating a steering command and a speed command such that the vehicle travels along the optimal path planned in the optimal path planning step S1940. The vehicle control command generation step S1945 corresponds to an operation performed by the vehicle controller 1465 of FIG. 14. In this step, a control command may be generated such that the vehicle accurately follows the planned path by using a PID controller, a Model Predictive Control (MPC) controller, or a similar control algorithm. The generated steering command controls a steering angle of the vehicle, and the speed command controls acceleration or deceleration of the vehicle. The generated control command is transmitted to the vehicle driving system 1480 through the output unit 1470 of FIG. 14 to control an actual steering angle and a speed of the vehicle.

As described above, FIG. 19 clearly shows, step by step, an entire flow of a method of recognizing an environment by using the monocular camera and the inertial measurement unit, which are a low-cost sensor combination, planning a driving path dynamically optimized according to a mission objective, and controlling the vehicle in the unpaved road environment. The method of the present invention may be repeatedly performed in real time and continuously adapt to a dynamically changing environment, and through this, safe and efficient autonomous driving in the unpaved road environment may be realized.

A computer-readable storage medium is described. The computer-readable storage medium may store one or more programs. The one or more programs may be executed by at least one processor of an electronic device including a camera. The one or more programs may cause the electronic device to obtain a first image via the camera, perform object recognition on objects included in the first image by executing a first artificial intelligence model using the first image, obtain, as result information of the object recognition, class information indicating the objects recognized in respective regions of the first image, and the first artificial intelligence model may be trained by a second artificial intelligence model based on distillation learning. The second artificial intelligence model may be configured to generate an embedding vector from a second image, and may be trained to distinguish objects included in the second image based on the embedding vector.

For example, the second artificial intelligence model may be trained based on a comparison between a first embedding vector generated from the second image and a second embedding vector of a class word corresponding to classes of the objects.

For example, the second artificial intelligence model may be configured to compare the first embedding vector generated from the second image with respective second embedding vectors of a plurality of the class words, and determine, as a class of an object corresponding to the first embedding vector, a class corresponding to an embedding vector of a class word having the highest similarity among the second embedding vectors.

For example, the second artificial intelligence model may include an embedding model configured to generate the embedding vector from feature information obtained from the second image, and a mask model configured to identify, within the second image, a region corresponding to the embedding vector.

For example, the mask model may be configured to generate, based on the embedding vector, masks corresponding to the respective objects within the second image.

For example, the first artificial intelligence model may be configured to identify an event related to the first image using the obtained class information, and based on identifying the event, cause an alarm to be output.

For example, the class information may further include identification information assigned to each of the objects which is configured to distinguish the objects included in a same class from one another.

A method is described. The method may train an artificial intelligence model. The method may comprise obtaining, using an image, feature information corresponding to the image by executing the artificial intelligence model, generating, from the feature information, a first embedding vector based on an embedding space representing relationships among words, comparing the first embedding vector with second embedding vectors respectively corresponding to class words for classifying classes of objects, and based on the comparison between the first embedding vector and the second embedding vectors, training the artificial intelligence model.

For example, the artificial intelligence model may include an embedding model configured to generate the first embedding vector from the feature information obtained from the image, and a mask model configured to identify, within the image, a region corresponding to the first embedding vector.

For example, the mask model may be configured to generate, based on the first embedding vector, masks corresponding to respective objects within the image.

For example, class information may further include identification information assigned to each of the objects and configured to distinguish objects belonging to the same class from one another.

For example, the artificial intelligence model may be a teacher model, and the method may further comprise, based on training of the teacher model, identifying reference images for training a student model, and generating pseudo ground truth information indicating results of object recognition performed on each of the reference images by executing the teacher model using the reference images.

For example, the student model may be executable by an electronic device attachable to a vehicle and including a camera.

For example, the image may be obtained via the camera.

An electronic device is described. The electronic device may comprise a camera, memory, and a processor. The processor may be configured to cause the electronic device to obtain a first image via the camera, perform object recognition on objects included in the first image by executing a first artificial intelligence model using the first image, obtain, as result information of the object recognition, class information indicating the objects recognized in respective regions of the first image, and the first artificial intelligence model may be trained by a second artificial intelligence model based on distillation learning. The second artificial intelligence model may be configured to generate an embedding vector from a second image, and may be trained to distinguish objects included in the second image based on the embedding vector.

For example, the second artificial intelligence model may be trained based on a comparison between a first embedding vector generated from the second image and a second embedding vector of a class word corresponding to classes of the objects.

For example, the second artificial intelligence model may be configured to compare the first embedding vector generated from the second image with respective second embedding vectors of a plurality of the class words, and determine, as a class of an object corresponding to the first embedding vector, a class corresponding to an embedding vector of a class word having the highest similarity among the second embedding vectors.

For example, the second artificial intelligence model may include an embedding model configured to generate the embedding vector from feature information obtained from the second image, and a mask model configured to identify, within the second image, a region corresponding to the embedding vector.

For example, the mask model may be configured to generate, based on the embedding vector, masks corresponding to respective objects within the second image.

For example, the first artificial intelligence model may be configured to identify an event related to the first image using the obtained class information, and based on identifying the event, cause an alarm to be output.

The technical problems to be achieved in the present disclosure are not limited to those described above, and other technical problems not mentioned may be clearly understood by those having ordinary skill in the art to which the present disclosure pertains.

1. A computer-readable storage medium storing one or more programs,
wherein the one or more programs, when executed by at least one processor of an electronic device including a camera, cause the electronic device to:
obtain a first image via the camera;
perform object recognition on objects included in the first image by executing a first artificial intelligence model using the first image;
obtain, as result information of the object recognition, class information indicating the objects recognized in respective regions of the first image;
wherein the first artificial intelligence model is trained by a second artificial intelligence model based on distillation learning; and
wherein the second artificial intelligence model is configured to generate an embedding vector from a second image, and is trained to distinguish objects included in the second image based on the embedding vector.

2. The computer-readable storage medium of claim 1,
wherein the second artificial intelligence model is trained based on a comparison between a first embedding vector generated from the second image and a second embedding vector of a class word corresponding to classes of the objects.

3. The computer-readable storage medium of claim 2,
wherein the second artificial intelligence model is configured to:
compare the first embedding vector generated from the second image with respective second embedding vectors of a plurality of the class words; and
determine, as a class of an object corresponding to the first embedding vector, a class corresponding to an embedding vector of a class word having the highest similarity among the second embedding vectors.

4. The computer-readable storage medium of claim 1,
wherein the second artificial intelligence model includes:
an embedding model configured to generate the embedding vector from feature information obtained from the second image; and
a mask model configured to identify, within the second image, a region corresponding to the embedding vector.

5. The computer-readable storage medium of claim 4,
wherein the mask model is configured to generate, based on the embedding vector, masks corresponding to the respective objects within the second image.

6. The computer-readable storage medium of claim 1,
wherein the first artificial intelligence model is configured to:
identify an event related to the first image using the obtained class information; and
based on identifying the event, cause an alarm to be output.

7. The computer-readable storage medium of claim 1,
wherein the class information further includes identification information assigned to each of the objects which is configured to distinguish the objects included in a same class from one another.

8. A method for training an artificial intelligence model, the method comprising:
obtaining, using an image, feature information corresponding to the image by executing the artificial intelligence model;
generating, from the feature information, a first embedding vector based on an embedding space representing relationships among words;
comparing the first embedding vector with second embedding vectors respectively corresponding to class words for classifying classes of objects; and
based on the comparison between the first embedding vector and the second embedding vectors, training the artificial intelligence model.

9. The method of claim 8, wherein the artificial intelligence model includes:
an embedding model configured to generate the first embedding vector from the feature information obtained from the image; and
a mask model configured to identify, within the image, a region corresponding to the first embedding vector.

10. The method of claim 9, wherein the mask model is configured to generate, based on the first embedding vector, masks corresponding to respective objects within the image.

11. The method of claim 8, wherein class information further includes identification information assigned to each of the objects and configured to distinguish objects belonging to the same class from one another.

12. The method of claim 8,
wherein the artificial intelligence model is a teacher model, and
the method further comprises:
based on training of the teacher model, identifying reference images for training a student model; and
generating pseudo ground truth information indicating results of object recognition performed on each of the reference images by executing the teacher model using the reference images.

13. The method of claim 12, wherein the student model is executable by an electronic device attachable to a vehicle and including a camera.

14. The method of claim 13, wherein the image is obtained via the camera.

15. An electronic device for executing an artificial intelligence model comprising:
a camera;
memory; and
a processor,
wherein the processor is configured to cause the electronic device to:
obtain a first image via the camera;
perform object recognition on objects included in the first image by executing a first artificial intelligence model using the first image;
obtain, as result information of the object recognition, class information indicating the objects recognized in respective regions of the first image,
wherein the first artificial intelligence model is trained by a second artificial intelligence model based on distillation learning; and
wherein the second artificial intelligence model is configured to generate an embedding vector from a second image, and is trained to distinguish objects included in the second image based on the embedding vector.

16. The electronic device of claim 15,
wherein the second artificial intelligence model is trained based on a comparison between a first embedding vector generated from the second image and a second embedding vector of a class word corresponding to classes of the objects.

17. The electronic device of claim 16,
wherein the second artificial intelligence model is configured to:
compare the first embedding vector generated from the second image with respective second embedding vectors of a plurality of the class words; and
determine, as a class of an object corresponding to the first embedding vector, a class corresponding to an embedding vector of a class word having the highest similarity among the second embedding vectors.

18. The electronic device of claim 15,
wherein the second artificial intelligence model includes:
an embedding model configured to generate the embedding vector from feature information obtained from the second image; and
a mask model configured to identify, within the second image, a region corresponding to the embedding vector.

19. The electronic device of claim 18,
wherein the mask model is configured to generate, based on the embedding vector, masks corresponding to respective objects within the second image.

20. The electronic device of claim 15,
wherein the first artificial intelligence model is configured to:
identify an event related to the first image using the obtained class information; and
based on identifying the event, cause an alarm to be output.
